(19) United States
(12) Patent Application Publication
(10) Pub. No.: US 2026/0108801 A1
(43) Pub. Date: Apr. 23, 2026

(54) INTELLIGENT CHESS DEVICE AND MODULAR CHESS DEVICE

(71) Applicant: FS GIIKER TECHNOLOGY CO., LTD., Foshan (CN)

(72) Inventors: Ziming SU, Foshan (CN); Changping LI, Foshan (CN); Leilei ZHANG, Foshan (CN)

(21) Appl. No.: 19/390,366

(22) Filed: Nov. 14, 2025

Related U.S. Application Data
(63) Continuation of application No. PCT/CN2024/143331, filed on Dec. 27, 2024.

(30) Foreign Application Priority Data
Dec. 29, 2023 (CN) 202311873126.5
Dec. 29, 2023 (CN) 202323667849.8
Dec. 29, 2023 (CN) 202323668565.0
Dec. 29, 2023 (CN) 202323668947.3

(51) Int. Cl. A63F 3/00; A63F 3/02; A63F 9/18; A63F 9/24

(52) U.S. Cl. CPC A63F 3/00643; A63F 3/02; A63F 9/18; A63F 9/24; A63F 2003/00652; A63F 2009/2457

(57) ABSTRACT

The present disclosure belongs to the field of intelligent hardware, and particularly relates to an intelligent chess device and a modular chess device. The intelligent chess device of the present disclosure includes a chessboard, the chessboard being divided into a plurality of chess grids, and each chess grid corresponding to one piece of chess piece position information; a control module; a chess piece information input module, configured to at least receive chess piece position information input by a user and communicate with the control module; and a display module, configured to be controlled by the control module to respond to the chess piece position information input by the user, so as to present corresponding display information on the chessboard.

### CROSS-REFERENCE TO RELATED APPLICATION

The present application is a continuation of the international patent application No. PCT/CN2024/143331 filed on Dec. 27, 2024, which claims priority from Chinese patent applications No. 202311873126.5, 202323667849.8, 202323668947.3 and 202323668565.0 filed on Dec. 29, 2023. All the aforementioned patent applications are incorporated herein by reference in their entirety.

### TECHNICAL FIELD

The present disclosure generally belongs to the field of intelligent hardware, and specifically relates to intelligent chess device and modular chess device.

### BACKGROUND

Tic-tac-toe is a traditional game. Classic tic tic-tac-toe is a ball game that is usually played on a 3×3 cell, like quintuple. Since the chessboard of tic-tac-toe is typically not bordered, its cell lines are arranged in a “tic-tac-toe”, hence the name tic-tac-toe. The game, tic-tac-toe, is extremely easy to play, requiring only paper and pen tools. In the game, two players representing “O” and “X” respectively take turns to leave marks in the cell, usually the pioneer being the side using “X”. The rule of victory in classic tic tic-tac-toe chess is that three marks on either side form a straight line and a win is judged.

In the existing playing method, in addition to the above-mentioned method of using paper and pencil to write, you can also use a physical toy board, and both sides can play the game by chess playing.

It can be seen that the above-mentioned existing playing methods all need to use physical elements (such as paper and pencil, chess pieces, etc.). This not only causes the connection between multiple games not smooth, but is also inconvenient for carrying for entertainment, and the applicable scenes have strong limitations.

Therefore, there is a need for an intelligent chess device that not only solves the above-mentioned deficiencies of traditional tic-tac-toe chess, but also expands a variety of new play methods that satisfy portability while exploiting playability, giving intelligence to traditional games.

### SUMMARY

In accordance with an aspect of the present disclosure, there is provided a display module including: a plurality of display units each including a light-emitting component configured to provide at least one kind of display information, the plurality of display units being provided to be operable independently of each other; a display panel arranged to display the display information; a light processing component configured to process light emitted by the light-emitting component, the light processing component including a light-shielding plate, the light-shielding plate including a light-transmitting part; wherein the light-transmitting part is configured to cooperate with a corresponding light-emitting component to form the at least one display information.

The display module proposed by the present disclosure may include one or more of the following further developments according to different embodiments.

According to some embodiments, the light-emitting component of each of the display units comprises: a first light-emitting component configured to provide first display information; and a second light-emitting component configured to operate independently of the first light-emitting component and capable of providing second display information different from the first display information.

According to some embodiments, preferably, the light-transmitting part of the light-shielding plate includes: a first light-transmitting part configured to cooperate with the first light-emitting component to form the first display information; a second light-transmitting part configured to cooperate with the second light-emitting component to form the second display information.

According to some embodiments, preferably, the first light-emitting component is aligned with the first light-transmitting part; and/or the second light-emitting component is aligned with the second light transmitting part.

According to some embodiments, preferably, the first light-transmitting part is provided to be generally circular; and/or the second light-transmitting part is arranged to be generally cross-shaped.

According to some embodiments, preferably, the intersection point of two intersection lines forming the cross-shaped second light-transmitting part is the center of the circle of the first light-transmitting part that is generally circular.

According to some embodiments, the two intersection lines of the second light-transmitting part each extend along the diameter of the generally circular first light-transmitting part to divide the first light-transmitting part into four separate arc segments.

According to some embodiments, the lighting assembly is configured to provide controllable color and/or pattern and/or brightness.

According to some embodiments, the light-emitting component is an LED lamp.

According to some embodiments, the portion of the light-shielding plate other than the light-transmitting part is made of an opaque material.

According to some embodiments, the light-shielding plate is a single integral piece.

According to some embodiments, the light processing component further includes a light uniformity film disposed on one side of the light-shielding plate.

According to some embodiments, the light uniformity film is a white film.

According to some embodiments, the light processing component further includes a sharp-light plate disposed on a side of the light uniformity film opposite to the light-shielding plate.

According to some embodiments, the sharp-light plate is a black semi-transparent member.

According to some embodiments, the sharp-light plate constitutes the display panel.

According to some embodiments, the display module further includes a pattern display component configured to display a panel pattern on the display panel.

According to some embodiments, a concave pattern is provided on a side of the light-shielding plate facing the display panel, and the concave pattern accommodates the pattern display component.

According to some embodiments, the pattern display component is an LED light.

According to some embodiments, the panel pattern is a tic-tac-toe pattern.

Another aspect of the present disclosure proposes an intelligent chess device, which includes a display module having one or more of the aforementioned features.

According to some embodiments of the intelligent chess device of the present disclosure, the intelligent chess device further includes a control module configured to control the operation of the display module.

According to some embodiments of the intelligent chess device of the present disclosure, the intelligent chess device further includes: a chessboard, the chessboard is divided into a plurality of chess grids, and each chess grid corresponds to a piece of chess piece position information; a chess piece information input module configured to input chess piece position information by a user.

According to some embodiments of the intelligent chess device of the present disclosure, the chess piece information input module is configured to be communicatively connected with the control module, and the control module is configured to control the display module in response to the chess piece position information input by the user. Corresponding display information is presented on the display panel.

According to some embodiments of the intelligent chess device of the present disclosure, each display unit of the display module is arranged corresponding to one of the plurality of chess grids.

According to some embodiments of the intelligent chess device of the present disclosure, the display panel constitutes the chessboard.

According to some embodiments of the intelligent chess device of the present disclosure, the chess piece information input module is a capacitive touch key module.

According to some embodiments of the intelligent chess device of the present disclosure, the chess piece information input module includes a sensor chip, a control circuit communicatively connected to the sensor chip, and a sensing electrode provided corresponding to each of the plurality of chess grids, the sensor chip is used to sense the electric field signal of the sensing electrode, and the control circuit is used to process the electric field signal.

According to some embodiments of the intelligent chess device of the present disclosure, the sensor chip and the control circuit are disposed on a circuit board of the control module, and each of the sensing electrodes is disposed between the chessboard and the circuit board. A metal sheet or spring between them.

According to some embodiments of the intelligent chess device of the present disclosure, the light-shielding plate is further provided with a holding groove for holding a corresponding sensing electrode.

According to some embodiments of the intelligent chess device of the present disclosure, the sensing electrode is a coil spring, the holding groove is disposed around the first light-transmitting part among the light-transmitting parts, and the coil spring passes through the holding groove. Set between the chessboard and the circuit board.

According to some embodiments of the intelligent chess device of the present disclosure, the light-shielding plate includes an inner peripheral wall and an outer peripheral wall forming the holding groove, and at least one of the inner peripheral wall and the outer peripheral wall is disposed from the light-shielding plate. Extending a length toward the circuit board to reach the circuit board.

According to some embodiments of the intelligent chess device of the present disclosure, the light-emitting component is disposed on the circuit board.

According to some embodiments of the intelligent chess device of the present disclosure, the light-shielding plate includes a peripheral wall extending from the light-shielding plate to the circuit board.

According to some embodiments of the intelligent chess device of the present disclosure, the intelligent chess device is tic-tac-toe or memory splash.

According to another aspect of the present disclosure, an intelligent chess device is proposed, including: a chessboard divided into a plurality of chess grids, each chess grid corresponding to a piece of chess piece position information; a control module; a chess piece information input module configured to receive at least chess piece position information input by a user and communicate with the control module; a display module configured to be controlled by the control module to present corresponding display information on the board in response to user input chess piece position information.

The intelligent chess device proposed by the present disclosure may also include one or more of the following further developments according to different embodiments.

According to some embodiments, the display module comprises a display unit corresponding to each of the plurality of chess grids, each of the display units comprising: a first display component configured to provide first display information; and a second display component configured to provide second display information different from the first display information.

According to some embodiments, the first display component includes a first light-emitting component and the second display component includes a second light-emitting component.

According to some embodiments, the first display information differs in color and/or pattern from the second display information.

According to some embodiments, the display module further comprises a light processing component arranged to allow processing of light emitted by the first light-emitting component and the second light-emitting component to display the first display information and the second display information respectively on the board.

According to some embodiments, the light processing component includes a light-shielding plate, the light-shielding plate is provided with a first light-transmitting part and a second light-transmitting part, the first light-transmitting part is configured to transmit light emitted by the first light-emitting component to form the first display information, and the second light-transmitting part is configured to transmit light emitted by the second light-emitting component to form the second display information,

According to some embodiments, the first light-emitting component is aligned with the first light-transmitting part; and/or the second light-emitting component is aligned with the second light transmitting part.

According to some embodiments, the first light-transmitting part is configured to be generally circular; and/or the second light-transmitting part is arranged to be generally cross-shaped.

According to some embodiments, the intersection point of the two intersection lines forming the cross-shaped second light-transmitting part is the center of the circle of the first light-transmitting part that is generally circular.

According to some embodiments, the two intersection lines of the second light-transmitting part each extend along the diameter of the generally circular first light-transmitting part to divide the first light-transmitting part into four separate arc segments.

According to some embodiments, the light-shielding plates of at least some of the display units is integrally formed.

According to some embodiments, the first light-emitting component comprises a first set of LED lights; and/or the second light-emitting component comprises a second set of LED lights.

According to some embodiments, the light processing component further includes a light uniformity film disposed between the light-shielding plate and the chessboard.

According to some embodiments, the light processing component includes a sharp-light plate disposed on a side of the light uniformity film facing away from the light-shielding plate.

According to some embodiments, the chessboard comprises a chessboard pattern disposed on the sharp-light plate.

According to some embodiments, the grid pattern is tic-tac-toe.

According to some embodiments, the control module is further configured to independently control the operation of each display unit.

According to some embodiments, the control module is configured to be able to control either or both of the first display component and the second display component of the corresponding display unit to turn on at the same time.

According to some embodiments, when only one of the first display component and the second display component of the corresponding display unit is turned on: the first display information represents the first chess piece identity, and the second display information represents the second chess piece identity; or the first display information represents a chess piece, and the second display information represents an error indication or game end information.

According to some embodiments, when both of the first display component and the second display component of the corresponding display unit are turned on simultaneously: the first display information and the second display information represent game level information.

According to some embodiments, the number or position of chess grids displaying the first display information and the second display information simultaneously may represent a game level.

According to some embodiments, the control module is configured to be able to control the operating states of the first display component and the second display component of the corresponding display unit to display the first display information and the second display information in different states accordingly.

According to some embodiments, wherein the first display component and the second display component are configured to present different brightness or flashing frequencies when in different operating states.

According to some embodiments, the intelligent chess device is configured to include a plurality of game modes.

According to some embodiments, further comprising a game mode selection module configured to receive user input game mode selection information and enter one of the plurality of game modes via the control module.

According to some embodiments, in a first game mode of the plurality of game modes, the control module is configured to control only one of the first display component and the second display component of the corresponding display unit to turn on, wherein the first display information represents the first chess piece identity and the second display information represents the second chess piece identity.

According to some embodiments, the first game mode is a chess game mode; the first piece identity representing a first one of the two sides of the game; the second player identity representing a second one of the two parties of the game.

According to some embodiments, it is configured to alternately perform chess arranging operations by the first party and the second party in the game, wherein the chess arranging operations are: by one of the first party and the second party, input of chess piece position information by the user; or controlling, by the control module as one of the first party and the second party, the display module to display the first display information or the second display information respectively on the respective chess grids.

According to some embodiments, the control module is configured to determine a game end state in the game state, and when it is determined that the game ends, control all first display components or all second display components of the display unit in the on state to flash Several times to indicate the victory of the corresponding first party or second party.

According to some embodiments, the control module is configured to determine the triggering of an intermediate progress state in the game state, and in response to each subsequent chess arranging operation after determining the triggering of the intermediate progress state and before the game ends. Operation controls the operation of a corresponding display unit in the on state.

According to some embodiments, the control module is configured to control the one corresponding display unit to transition from an on state to an off state.

According to some embodiments, it is configured to keep the remaining display units in the on state except the one corresponding display unit in the on state.

According to some embodiments, it is configured that the intermediate progress state is triggered by the Nth movement after the game starts, and N is an integer in the range of 5-7.

According to some embodiments, N is equal to 6.

According to some embodiments, the control module is further configured to first transition from the full-light state to the half-light state before controlling the one corresponding display unit to transition to the extinguished state.

According to some embodiments, the control module is configured to control the one corresponding display unit to change from a full-light state to a half-light state when performing a chess arranging operation before a subsequent chess arranging operation corresponding to the off operation.

According to some embodiments, the display unit of the grid corresponding to the first N cloth operations of each the subsequent operation is the one corresponding display unit

According to some embodiments, only one of the first party and the second party is a user, wherein the control module is further configured to control the input of chess piece position information of the other of the first party and the second party.

According to some embodiments, both of the first party and the second party are users.

According to some embodiments, a sound-emitting module is further included, the sound-emitting module is controlled by the control module to sound to indicate at least one of the following game items: opening of the smart board; entry of the first game mode; the correct input of the position information of the chess piece by the user or the control module; incorrect input of the position information of the chess piece by the user; the end of the game.

According to some embodiments, the sound-emitting module is further configured to emit different sounds to indicate different game items.

According to some embodiments, in a second game mode of the plurality of game modes, the control module is configured to be able to control only one of the first display component and the second display component of the corresponding display unit to turn on; wherein, the first display information represents a chess piece, and the second display information represents an error instruction or a game end instruction.

According to some embodiments, the first display information is blue; the second display information is red.

According to some embodiments, the second game mode includes one or more game levels.

According to some embodiments, each of the game levels comprises one or more game sessions.

According to some embodiments, each of the game sessions includes a question-generating mode and a question-answering mode that are progressed sequentially.

According to some embodiments, the control module is further configured to control the intelligent chess device to automatically switch to the answer mode when the answer mode ends.

According to some embodiments, the control module is further configured to perform a question-generating operation in the question-generating mode of the corresponding game session.

According to some embodiments, the question-answering operation comprises performing a chess arranging operation on at least two randomly selected chess grids of the plurality of chess grids in a predetermined order.

According to some embodiments, each of the moving operations includes turning on a first display element or a second display element of a display unit corresponding to the randomly selected chess grids.

According to some embodiments, each of the operations includes turning on the first display component or the second display component of the corresponding display unit to a full-light state and then to a half-light state, and at the end of the operation of solving, all the turned-on display units are in a half-light state.

According to some embodiments, the answer mode includes an answer operation.

According to some embodiments, the answer operation includes receiving chess piece position information input by the user via the chess piece information input module.

According to some embodiments, the answer operation further includes determining, via the control module, whether the user inputs chess piece position information corresponding to the at least two randomly selected chess grids in the predetermined order or the reverse order of the predetermined order.

According to some embodiments, the answer operation further includes operating the display module according to the judgment result via the control module.

According to some embodiments, the answer operation includes: when the control module determines that the user is inputting the chess piece position information corresponding to the at least two randomly selected chess grids in the predetermined order or the reverse order of the predetermined order., the control module operates the corresponding display unit: from a half-light state to a full-light state, or from a half-light state to a full-light state and then to an extinguished state; and/or, in the event that the control module determines that the user has not entered the positional information of the pieces corresponding to the at least two randomly selected chess grids in the predetermined order or in the reverse order of the predetermined order, the control module operates the respective display unit to provide an error indication or a game over indication.

According to some embodiments, the error indication or the game end indication is implemented by switching between first display information and second display information displayed by the corresponding display unit.

According to some embodiments, the intelligent chess device further includes a sound-emitting module, wherein the control module is further configured to control the sound-emitting module to: emit a sound concomitantly with the chess arranging operation during the question-generating operation; and/or emitting a sound accompanying the input of the chess piece position information during the question-answering operation.

According to some embodiments, the sound-emitting module is further configured to utter each sound as at least one note of the set of notes do, re, mi, fa, sol, la, si.

According to some embodiments, it is further configured to assign a note to each chess operation in the questioning operation, the note being from a subset of notes selected from the set of notes corresponding to a given arrangement, the notes in the subset of notes being arranged from bass to treble or from treble to bass in the given arrangement, wherein: all assigned notes of the randomly selected chess grids constitute a note sequence according to the predetermined order, the note sequence being the subset of notes or the subset of notes and the at least partial repetition of the subset of notes; and/or the answer operation is the user's repetition of the answer operation in the predetermined order or the reverse repetition of the answer operation in the reverse order of the predetermined order. Each answer operation is played when the answer is correct. Notes assigned to the corresponding chess operation are played, and/or an error indication sound is played if the answer is wrong.

According to some embodiments, the subset of notes is less than or equal to the set of notes.

According to some embodiments, further comprising a storage unit having stored therein one or more topics corresponding to each game session; the question-answering operation comprising extracting, by the control module, one of the questions prior to performing the piece arranging operation, the question comprising the predetermined sequence for performing the piece arranging operations.

According to some embodiments, the title includes the note sequence.

According to some embodiments, the sound-emitting module is further configured to control sound production by the control module to indicate at least one of the following game items: opening of the intelligent chess device; entry of the second game mode; clearance of each of the game sessions; clearance of each of the game levels; a level of each of the game levels or game sessions; clearance of all game sessions of all game levels.

According to some embodiments, the sound-emitting module is further configured to emit different sounds to indicate different game items.

According to some embodiments, the question-answering operation comprises performing a single or a plurality of pieces of chess arranging operations on at least two randomly selected chess grids of the plurality of chess grids in a predetermined order.

According to some embodiments, each of the dispensing operations includes turning on a first display element or a second display element of a display unit corresponding to the randomly selected chess grid to a full-light state and then to a half-light state; at the end of the question-answering operation, all the turned-on display units are in a half-light state.

According to some embodiments, the answer mode includes an answer operation.

According to some embodiments, the answer operation includes receiving chess piece position information input by the user via the chess piece information input module.

According to some embodiments, the answer operation further includes determining, via the control module, whether the user inputs chess piece position information corresponding to the at least two display units in the predetermined order or the reverse order of the predetermined order.

According to some embodiments, the answer operation further includes operating the display module according to the judgment result via the control module.

According to some embodiments, the answer operation includes: when the control module determines that the user is inputting the chess piece position information corresponding to the at least two display units in the predetermined order or the reverse order of the predetermined order, the control module operates the corresponding display unit: from a half-light state to a full-light state, or from a half-light state to a full-light state and then to an extinguished state; and/or in the event that the control module determines that the user has not entered the positional information of the pieces corresponding to the at least two randomly selected chess grids in the predetermined order or in the reverse order of the predetermined order, the control module operates the respective display unit to provide an error indication or a game over indication.

According to some embodiments, the error indication or the game end indication is implemented by switching between first display information and second display information displayed by the corresponding display unit.

According to some embodiments, the intelligent chess device further includes a sound-emitting module, wherein the control module is further configured to control the sound-emitting module to: emit a sound concomitantly with the chess arranging operation during the question-generating operation; and/or emitting a sound accompanying the input of the chess piece position information during the question-answering operation.

According to some embodiments, the sound-emitting module is further configured to utter each sound as at least one note of the set of notes do, re, mi, fa, sol, la, si.

According to some embodiments, it is further configured to assign a note to each of the at least two randomly selected chess grids, wherein: the sound generating module is configured to play a corresponding note when performing the arranging operation on the respective randomly selected grid during the telling operation; and/or the question-answering operation is a repetition of the question-answering operation by the user in the predetermined order or a reverse repetition of the question-answering operation in the reverse order of the predetermined order, each question-answering operation playing a note assigned to the corresponding randomly selected grid in case the question-answering is correct, and/or playing an error indication sound in case the question-answering is wrong.

According to some embodiments, it is further configured that during the question-generating operation, the at least two randomly selected chess grids are ordered sequentially according to an order in which a first arranging operation is performed on each of the randomly selected chess grids, and the at least two randomly selected chess grids are assigned notes arranged from bass to treble or treble to bass according to the sequential ordering.

According to some embodiments, further comprising a storage unit having stored therein one or more topics corresponding to each game session; the question-answering operation comprising extracting, by the control module, one of the questions prior to performing the piece arranging operation, the question comprising the predetermined sequence for performing the piece arranging operation.

According to some embodiments, the title includes the assigned notes for each of the randomly selected chess grids.

According to some embodiments, the sound-emitting module is further configured to control sound production by the control module to indicate at least one of the following game items: opening of the intelligent chess device; entry of the second game mode; clearance of each of the game sessions; clearance of each of the game levels; a level of each of the game levels or game sessions; clearance of all game sessions of all game levels.

According to some embodiments, the sound-emitting module is further configured to emit different sounds to indicate different game items.

According to some embodiments, the chess piece information input module is a capacitive touch key module.

According to some embodiments, the chess piece information input module includes a sensor chip, a control circuit communicatively connected to the sensor chip, and a sensing electrode provided corresponding to each of the plurality of chess grids, the sensor chip being used for sensing an electric field signal of the sensing electrode is sensed, and the control circuit is used to process the electric field signal.

According to some embodiments, the sensor chip and the control circuit are disposed on a circuit board of the control module, and each of the sensing electrodes is a metal sheet or spring disposed between the chessboard and the circuit board.

According to some embodiments, the light-shielding plate is further provided with a holding groove for holding the corresponding sensing electrode.

According to some embodiments, the sensing electrode is a coil spring, the holding groove is disposed around the first light-transmitting part, and the coil spring passes through the holding groove and is disposed between the chessboard and the circuit board.

According to some embodiments, the light-shielding plate includes an inner peripheral wall and an outer peripheral wall forming the retaining groove, and at least one of the inner peripheral wall and the outer peripheral wall is configured to extend from the light-shielding plate toward the circuit board by a length to reach the circuit board.

According to some embodiments, the first display component and the second display component are disposed on the circuit board.

According to some embodiments, the light-shielding plates of all display units constitute a single-piece light-shielding plate.

According to some embodiments, the light-shielding plate includes a peripheral wall extending from the light-shielding plate to the circuit board.

According to some embodiments, the one-piece light-shielding plate is provided with a concave pattern in the form of a tic-tac-toe, the concave pattern dividing the one-piece light-shielding plate into a plurality of portions, each portion corresponding to one of the chess grids.

According to some embodiments, the intelligent chessboard apparatus further comprises a third display element disposed in the concave pattern, the third display element forming a tic-tac-toe grid pattern on the chessboard in an on state.

According to some embodiments, the chess piece information input module includes a push-button module.

According to some embodiments, the chess piece information input module includes a light sensing module.

According to some embodiments, the game mode selection module is a dial or push-button selection module.

According to some embodiments, the intelligent chess device includes a power module.

According to another aspect of the present disclosure, a modular chess device is proposed, including an intelligent chess device with the aforementioned features and a traditional chess device.

According to yet another aspect of the present disclosure, a smart memory splash chess is presented, comprising:

A board, the board divided into a plurality of chess grids, each chess grid corresponding to a chess piece position information;

A control module;

A chess piece information input module configured to receive at least chess piece position information input by a user and communicate with the control module;

A display module configured to be controlled by the control module to present corresponding display information on the board in response to user input chess piece position information;

Wherein each game session of the smart memory game chess is provided with a question making mode and a question-answering mode, wherein the question making mode is performed by the control module.

According to various embodiments, the intelligent memory splash game proposed by the present disclosure may also include one or more of the following further developments.

In some embodiments, the display module comprises a display unit corresponding to each of the plurality of chess grids, each display unit comprising one or two display components configured to provide at least one display information.

In some embodiments, the display component is configured to be able to provide display information with different colors and/or different patterns and/or different brightness and/or flashing frequencies.

In some embodiments, the control module is configured to independently control each of the display units and to independently control each of the display components.

In some embodiments, the display component is a light-emitting component.

In some embodiments, the light-emitting component is an LED light.

In some embodiments, the display module further includes a light processing component, the light processing component is configured to process the light emitted by the light-emitting component, the light processing component includes a light-shielding plate, the light-shielding plate includes a light transmitting part; wherein the light-transmitting part is configured to cooperate with a corresponding light-emitting component to form the at least one display information.

In some embodiments, each of the display units includes: a first light-emitting component configured to provide first display information; and a second light-emitting component configured to provide second display information different from the first display information.

In some embodiments, the light-transmitting part includes: a first light-transmitting part configured to cooperate with the first light-emitting component to form the first display information; a second light-transmitting part configured to cooperate with the second light-emitting component to form the second display information.

In some embodiments, the first light-emitting component is aligned with the first light-transmitting part; and/or the second light-emitting component is aligned with the second light transmitting part.

In some embodiments, the first light-transmitting part is configured to be generally circular, and/or the second light-transmitting part is arranged to be generally cross-shaped.

In some embodiments, the intersection point of the two intersection lines forming the cross-shaped second light-transmitting part is the center of the circle of the first light-transmitting part that is generally circular.

In some embodiments, the two intersection lines of the second light-transmitting part each extend along the diameter of the generally circular first light-transmitting part to divide the first light-transmitting part into four separate arc segments.

In some embodiments, the portion of the light-shielding plate other than the light-transmitting part is formed of a non-light-transmitting material.

In some embodiments, the light-shielding plate is a single integral piece.

In some embodiments, the light processing component further includes a light uniformity film disposed between the light-shielding plate and the chessboard.

In some embodiments, the light uniformity film is a white film.

In some embodiments, the light processing component includes a sharp-light plate disposed on a side of the light uniformity film facing away from the light-shielding plate.

In some embodiments, the sharp-light plate is a black semi-transparent plate.

In some embodiments, the sharp-light plate constitutes the chessboard.

In some embodiments, a grid pattern can be presented on the board.

In some embodiments, the grid pattern is a tic-tac-toe pattern.

In some embodiments, the grid pattern is a tic-tac-toe structure disposed on a chessboard.

In some embodiments, the tic-tac-toe structures are arranged to protrude with respect to the board.

In some embodiments, the display module further comprises a display pattern display component disposed separately from the first display component and the second display component, the pattern display component configured to display the grid pattern on the chessboard.

In some embodiments, a concave pattern is provided on a side of the light-shielding plate facing the chessboard, and the concave pattern accommodates the pattern display component.

In some embodiments, the pattern display component is an LED light.

In some embodiments, the control module is configured to control only one of the first display component and the second display component of the corresponding display unit to turn on; wherein, the first display information represents a chess piece, and the second display information represents an error instruction or a game end instruction.

In some embodiments, the second game mode includes one or more game levels.

In some embodiments, each of the game levels includes one or more of the game sessions.

In some embodiments, the control module is further configured to control the intelligent chess device to automatically switch to the answer mode when the answer mode ends.

In some embodiments, the control module is further configured to perform a question-generating operation in the question-generating mode of the corresponding game session.

In some embodiments, the question-answering operation comprises performing a chess arranging operation on at least two randomly selected chess grids of the plurality of chess grids in a predetermined order.

In some embodiments, each of the movement operations includes turning on a first display component or a second display component of a display unit corresponding to the randomly selected grid.

In some embodiments, each of the operations includes turning on the first display component or the second display component of the corresponding display unit to a full-light state and then to a half-light state, and at the end of the question-answering operation, all Turned-on display units are in half-light state.

In some embodiments, the answer mode includes an answer operation.

In some embodiments, the answer operation includes receiving chess piece position information input by the user via the chess piece information input module.

In some embodiments, the answer operation further includes determining, via the control module, whether the user inputs chess piece position information corresponding to the at least two randomly selected chess grids in the predetermined order or the reverse order of the predetermined order.

In some embodiments, the answer operation further includes operating the display module according to the judgment result via the control module.

In some embodiments, the answer operation includes: when the control module determines that the user is inputting chess piece position information corresponding to the at least two randomly selected chess grids in the predetermined order or the reverse order of the predetermined order., the control module operates the corresponding display unit to: change from a half-light state to a full-light state, or from a half-light state to a full-light state and then change to an extinguished state; and/or in the event that the control module determines that the user has not entered the positional information of the pieces corresponding to the at least two randomly selected chess grids in the predetermined order or in the reverse order of the predetermined order, the control module operates the respective display unit to provide an error indication or a game over indication.

In some embodiments, the error indication or the game end indication is implemented by switching between first display information and second display information displayed by the corresponding display unit.

In some embodiments, a sound-emitting module is further included, wherein the control module is further configured to control the sound-emitting module to: emit a sound concomitantly with the chess arranging operation during the question-generating operation; and/or emitting a sound accompanying the input of the chess piece position information during the question-answering operation.

In some embodiments, the sound-emitting module is further configured to emit a sound each time as at least one note in the set of notes do, re, mi, fa, sol, la, si.

In some embodiments, the smart memory flash is further configured to assign a note to each of the questioning operations, the note being selected from a subset of notes corresponding to a given arrangement selected from the set of notes, the notes in the subset of notes being arranged from bass to treble or treble to bass in the given arrangement, wherein: all assigned notes of the randomly selected chess grids constitute a note sequence according to the predetermined order, the note sequence being the subset of notes or the subset of notes and the subset of notes; and/or the answer operation is the user's repetition of the answer operation in the predetermined order or the reverse repetition of the answer operation in the reverse order of the predetermined order. Each answer operation is played when the answer is correct. Notes assigned to the corresponding chess operation are played, and/or an error indication sound is played if the answer is wrong.

In some embodiments, the subset of notes is less than or equal to the set of notes.

In some embodiments, a memory unit is further included, the memory unit having stored therein one or more topics corresponding to each game session; the question-answering operation comprising extracting, by the control module, one of the questions prior to performing the piece arranging operation, the question comprising the predetermined sequence for performing the piece arranging operation.

In some embodiments, the title includes the note sequence.

In some embodiments, the sound production module is further configured to control sound production by the control module to indicate at least one of the following game items:
opening of the intelligent chess device;
entry of the second game mode;
clearance of each of the game sessions;
clearance of each of the game levels;
a level of each of the game levels or game sessions;
clearance of all game sessions of all game levels of the game levels.

In some embodiments, the sound-emitting module is further configured to emit different sounds to indicate different game items.

In some embodiments, the question-answering operation comprises performing a single or a plurality of pieces of chess arranging operations on at least two randomly selected chess grids of the plurality of chess grids in a predetermined order.

In some embodiments, each of the dispensing operations includes turning on a first display element or a second display element of a display unit corresponding to the randomly selected grid to a full-light state and then to a half-light state; at the end of the question-answering operation, all the turned-on display units are in a half-light state.

In some embodiments, the answer operation includes: when the control module determines that the user is inputting the chess piece position information corresponding to the at least two display units in the predetermined order or the reverse order of the predetermined order, the control module operates the corresponding display unit: from a half-light state to a full-light state, or from a half-light state to a full-light state and then to an extinguished state; and/or in the event that the control module determines that the user has not entered the positional information of the pieces corresponding to the at least two randomly selected chess grids in the predetermined order or in the reverse order of the predetermined order, the control module operates the respective display unit to provide an error indication or a game over indication.

In some embodiments, the smart memory flash is further configured to assign a note to each of the at least two randomly selected chess grids, wherein: the sound generating module is configured to play a corresponding note when performing the piece operation on the corresponding randomly selected grid during the problem setting operation; and/or the question-answering operation is a repetition of the question-answering operation by the user in the predetermined order or a reverse repetition of the question-answering operation in the reverse order of the predetermined order, each question-answering operation playing a note assigned to the corresponding randomly selected grid in case the question-answering is correct, and/or playing an error indication sound in case the question-answering is wrong.

In some embodiments, the smart memory flash is further configured such that, during the question-answering operation, the at least two randomly selected chess grids are ordered sequentially in an order in which a first arranging operation is performed on each of the randomly selected chess grids, and the at least two randomly selected chess grids are assigned notes arranged from bass to treble or treble to bass according to the sequential ordering.

In some embodiments, the title comprises the assigned notes for each of the randomly selected chess grids.

In some embodiments, each display unit includes a display component for representing a chess piece.

In some embodiments, the smart memory splash comprises a sounding module that indicates a wrong answer or an end of the game.

In some embodiments, the chess piece information input module is a capacitive touch key module.

In some embodiments, the chess piece information input module includes a sensor chip, a control circuit communicatively connected to the sensor chip, and a sensing electrode provided corresponding to each of the plurality of chess grids, the sensor chip being used for sensing an electric field signal of the sensing electrode is sensed, and the control circuit is used to process the electric field signal.

In some embodiments, the sensor chip and the control circuit are disposed on a circuit board of the control module, and each of the sensing electrodes is a metal sheet or spring disposed between the chessboard and the circuit board.

In some embodiments, the light-shielding plate is further provided with a holding groove for holding the corresponding sensing electrode.

In some embodiments, the sensing electrode is a coil spring, the holding groove is disposed around the first light-transmitting part, and the coil spring passes through the holding groove and is disposed between the chessboard and the circuit board between.

In some embodiments, the light-shielding plate includes an inner peripheral wall and an outer peripheral wall forming the retaining groove, and at least one of the inner peripheral wall and the outer peripheral wall is configured to extend from the light-shielding plate toward the circuit board. A length to reach the circuit board.

In some embodiments, the light-emitting component is disposed on the circuit board.

In some embodiments, the light-shielding plate includes a peripheral wall extending from the light-shielding plate to the circuit board.

In some embodiments, the chess piece information input module includes a push-button module.

In some embodiments, the chess piece information input module includes a light sensing module.

The present disclosure also proposes a modular chess device, including the intelligent chess device according to any one of the preceding embodiments and a traditional chess device.

### BRIEF DESCRIPTION OF DRAWINGS

In order to explain the technical solutions of the embodiments of the present disclosure more clearly, the drawings that need to be used in the embodiments will be briefly introduced below. It should be understood that the following drawings only show certain embodiments of the present disclosure and therefore do not It should be regarded as a limitation on the scope. For those of ordinary skill in the art, other relevant drawings can also be obtained based on these drawings without exerting creative efforts. In the drawings:

FIG. 1 is a schematic perspective view illustrating a display module according to an exemplary embodiment;

FIG. 2 is a schematic perspective view of a part of the display module shown in FIG. 1;

FIG. 3 is a top view of FIG. 2;

FIG. 4 is one display unit of a display module and an example of a pattern provided by the display unit according to an exemplary embodiment;

FIG. 5 is a schematic perspective view of an intelligent chess device according to an exemplary embodiment;

FIG. 6 is an exploded perspective view of an intelligent chess device according to an exemplary embodiment, which includes the display module shown in FIG. 1;

FIG. 7 is a longitudinal cross-sectional view of an intelligent chess device according to an exemplary embodiment;

FIG. 8 is a plan view of a board of an intelligent chess device according to an exemplary embodiment;

FIG. 9 is a schematic perspective view of a peripheral wall of a housing of an intelligent chess device according to an exemplary embodiment;

FIG. 10 is a schematic perspective view of a bottom cover and a control module of a housing of an intelligent chess device according to an exemplary embodiment;

FIG. 11 is a schematic perspective view of a control module of an intelligent chess device and certain components disposed thereon according to an exemplary embodiment;

FIG. 12 schematically shows the bottom cover of the housing of the intelligent chess device and the power module disposed therein according to an exemplary embodiment;

FIG. 13 is a schematic perspective view of a modular chess device according to an exemplary embodiment;

FIG. 14 is a schematic perspective view of a conventional chess device of a modular chess device according to an exemplary embodiment;

FIG. 15 is a schematic perspective view of a split board assembly of a conventional chess device of a modular chess device according to an exemplary embodiment;

FIG. 16 is a perspective schematic view of an assembled board assembly of a conventional chess device of a modular chess device according to an exemplary embodiment;

FIG. 17 is a schematic perspective view of a chess set of conventional chess device of a modular chess device according to an exemplary embodiment.

### LIST OF REFERENCE SIGNS

1 modular chess device
10 intelligent chess device
20 second device
100 display module
110 display unit
111 first display component
111a first light-emitting component
112 second display component
112a second light-emitting component
130 light-shielding plate
131 first light-transmitting part
131a, 131b, 131c, 131d arc segments
131e, 132e peripheral wall of the light-transmitting part
132 second light-transmitting part
132a, 132b intersection line
133 concave pattern
134 light-shielding plate area
135 non-light-transmitting part
137 peripheral wall
138 retaining slot
138a inner peripheral wall
138b outer peripheral wall
140 light uniformity film
150 sharp-light plate
150a display panel
150b chessboard
151 panel dividing pattern
151b grid pattern
152 chess grid
153 portion
155 snap claw
160 pattern display component
170 display unit
171 circuit board
200 control module
210 circuit board
310 sensing electrode
500 housing
510 peripheral wall
511 first end
512 receiving recess
513 second end
515 snap recess
520 bottom cover
521 power module cavity
600 power module
700 game mode selection module
810 chessboard
811 sub-member
820, 830 chess pieces
820a first large chess piece
820b first middle chess piece
820c first small chess piece
840 storage bin
P1, P2, P3 patterns.

### DETAILED DESCRIPTION

Below, a display module, an intelligent chess device, and a modular chess device according to embodiments of the present disclosure are described in detail with reference to the accompanying drawings. In order to make the purpose, technical solutions and advantages of the present practical disclosure clearer, the technical solutions in the embodiments of the present disclosure will be clearly and completely described below in conjunction with the accompanying drawings in the embodiments of the present disclosure. Obviously, the described embodiments are Some embodiments of this disclosure, but not all embodiments.

Thus, the following detailed description of the embodiments of the disclosure provided in connection with the appended drawings is not intended to limit the scope of the disclosure, as claimed, but is merely representative of selected embodiments of the disclosure. Based on the embodiments in this disclosure, all other embodiments obtained by those of ordinary skill in the art without creative efforts fall within the scope of protection of this disclosure.

Singular forms include plural forms unless the context otherwise defines. Throughout the specification, the terms “include”, “have”, and the like are used herein to specify the presence of stated features, numbers, steps, operations, elements, parts, or combinations thereof, but do not preclude the presence or addition of one or more other features, numbers, steps, operations, elements, parts, or combinations thereof.

In addition, even though terms including ordinal numbers such as “first”, “second”, etc. may be used to describe various components, these components are not limited by these terms, and these terms are only used to distinguish one element from other elements. For example, a first component could be termed a second component, and, similarly, a second component could be termed a first component, without departing from the scope of the present disclosure.

In the description of the present disclosure, it should be understood that the orientations or positional relationships indicated by the terms “upper”, “lower”, “left”, “right”, “inner”, “outer”, etc. are based on the orientations shown in the drawings. Or positional relationship, or the orientation or positional relationship that is customarily placed when using the disclosed product, or the orientation or positional relationship that is customarily understood by those skilled in the art. It is only for the convenience of describing the present disclosure and simplifying the description, rather than indicating or Implied that the equipment or element referred to must have a specific orientation, be constructed and operated in a specific orientation, and therefore cannot be understood as a limitation of the present disclosure.

### 1. Display Module

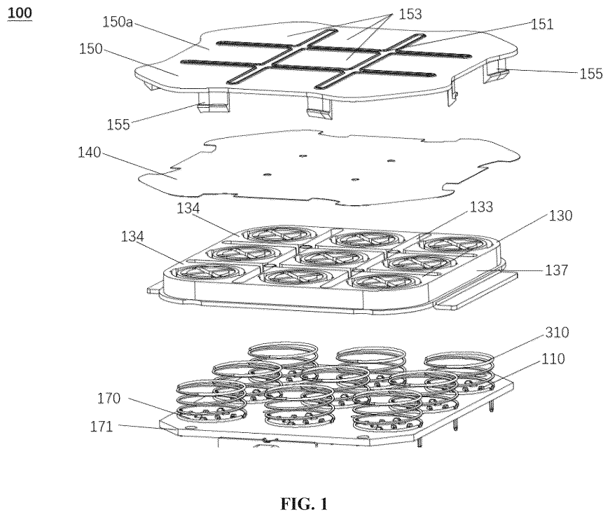

According to one aspect of the present disclosure, a display module 100 is proposed, as shown in FIGS. 1-4 and 6-7, which can provide display information required by the user. In some embodiments, the display module 100 may include one or more display units 110, each of which may include a display component 111, 112 configured to provide at least one display information to be presented, and more specifically to present desired display information corresponding to that display unit 110. More specifically, one or more display units 110 of the display module 100 may be disposed at different locations to provide required display information via the corresponding display unit 110 at a desired location. In some embodiments, each display unit 110 may be operated and controlled independently; more specifically, the respective display components 111, 112 of the respective display units 110 can be independently operated and controlled to, for example, turn on one or some or all of the display units 110 or at different brightness or flashing frequencies, or turn on one or some or all of the display components 111, 112 of each display unit 111, 112 or at different brightness or flashing frequencies, as desired. In some embodiments, the display components 111, 112 are configured to provide or present a controllable or variable color and/or pattern and/or brightness to provide desired display information via color and/or pattern and/or brightness and/or color transformation and/or pattern transformation and/or brightness transformation. In one embodiment, the display components 111, 112 may be light-emitting components 111a, 112a. In one embodiment, the display components 111, 112 are a set of LED lights.

In some embodiments, as shown in FIG. 1, the display module 100 may further include a display panel 150a configured to display the display information provided by each display unit 110.

In embodiments where the display components 111, 112 are light-emitting components 111a, 112a, more specifically, the display module 100 may further include a light processing component configured to allow light emitted by the light-emitting components 111a, 112a to be processed to display the required display information as desired. More specifically, the light processing component can control the pattern, brightness, softness, sharpness, etc. of the light emitted by the light-emitting components 111a and 112a.

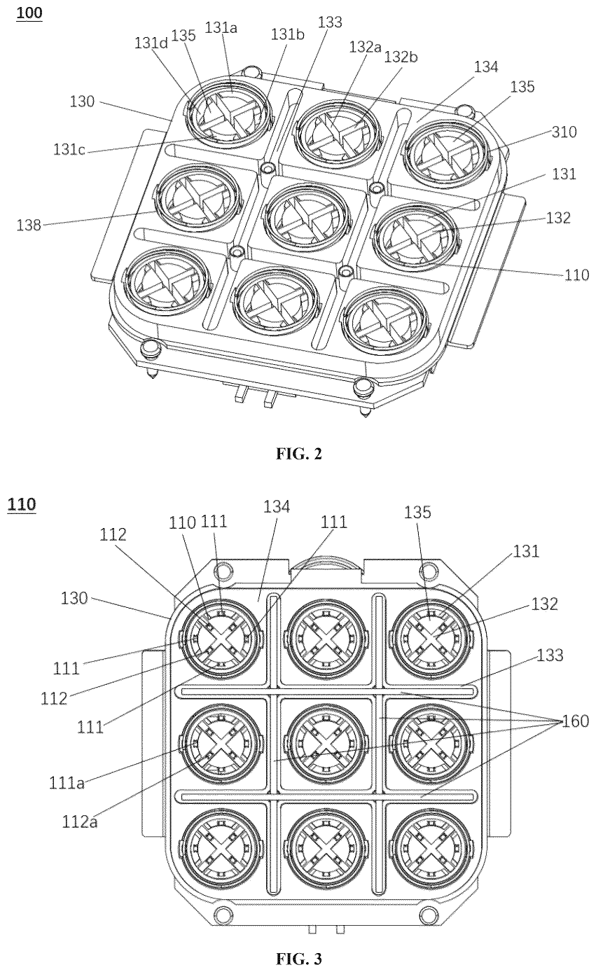

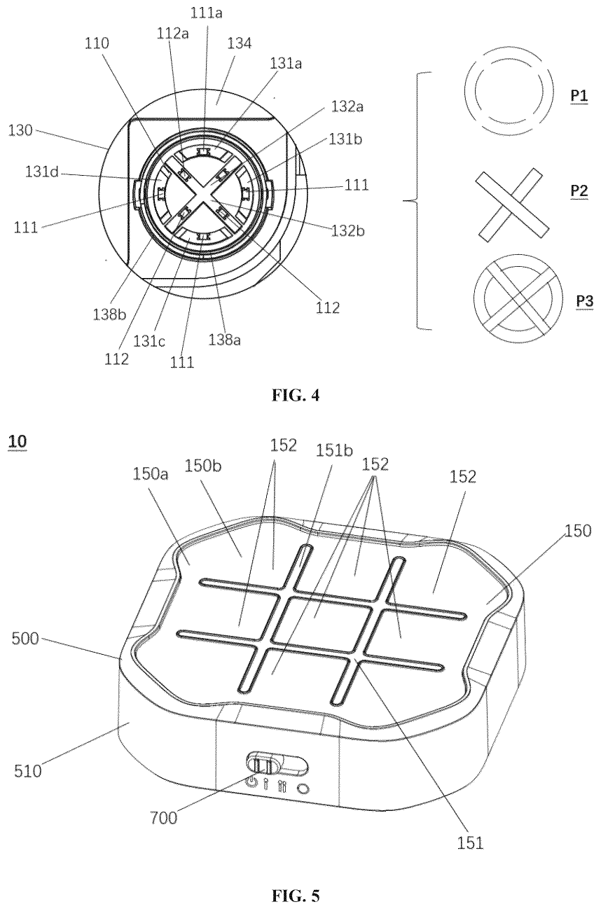

In some embodiments, as shown in FIGS. 1-4 and 6-7, the light processing component may include a light-shielding plate 130. The light-shielding plate 130 may be provided with light-transmitting parts 131 and 132 corresponding to the display components 111 and 112, and the light-transmitting parts 131 and 132 may cooperate with the display components 111 and 112 to form at least one type of display information. For example, the light-transmitting parts 131 and 132 are configured to allow the light emitted by the light-emitting components 111a and 112a to pass through to form desired display information. More specifically, as shown in FIG. 4, the light-transmitting parts 131 and 132 are configured to control the patterns P1 (circle), P2 (cross), and P3 (circle+cross) formed by the light emitted by the light-emitting components Illa and 112a. Different light patterns P1, P2, and P3 may represent or form the same or different display information. Alternatively, or additionally, the light-transmitting parts 131 and 132 may also be configured to be able to control the color of light emitted by the light-emitting components 111a and 112a, and different light colors may represent or form the same or different display information. More specifically, the light-shielding plate 130 cannot transmit light in the remaining portion i.e. non-light-transmitting part 135 other than the light-transmitting parts 131 and 132, that is, it is made of an opaque material. More specifically, the non-light-transmitting part of the light-shielding plate 130 is formed of a non-light-transmitting material such as plastic, rubber, or foam. In one embodiment, the non-light-transmitting part of the light-shielding plate 130 is black. In one embodiment, as shown in FIGS. 2-4 and 7, the light-transmitting parts 131 and 132 of the light-shielding plate 130 are hollowed-out parts of light-shielding material, that is, the light-shielding plate 130 does not have any material at the light-transmitting parts 131 and 132. In one embodiment, the light-emitting components 111a and 112a are arranged in alignment with the light-transmitting parts 131 and 132 of the light-shielding plate 130 to allow most of the light emitted by the light-emitting components 111a and 112a to pass through the light-transmitting parts 131 and 132 It plays the role of forming display information to enhance the display effect of the display information and improve the working efficiency of the light-emitting components 111a and 112a. More specifically, there is a certain distance between the light-emitting components 111a, 112a and the light-shielding plate 130, that is, they are not in contact or close proximity. In various embodiments, the light-transmitting parts 131 and 132 of the light-shielding plate 130 can be configured in various shapes such as generally circular, cross-shaped, rectangular, pentagonal, star-shaped, etc., which can be configured according to actual needs. In one embodiment, as shown in FIGS. 1-4 and 6-7, the light-shielding plate 130 is a single integral piece, that is, one integrated light-shielding plate 130 is used for each display unit 110 of the entire display module 100, which allows Simplified assembly and conducive to forming a stable overall structure.

In some embodiments, as shown in FIGS. 1 and 6-7, the light processing component may also include light-transmitting parts 131 and 132 disposed outside the light-shielding plate 130, that is, the light emitted by the light-emitting components 111a and 112a passes through the light-transmitting parts 131 and 132 of the light-shielding plate 130. Light uniformity film 140 on the side coming out. The light uniformity film 140 is configured to allow the light spot after light passes through to have a uniform brightness distribution. In one embodiment, the light uniformity film 140 is a white film. It can also be a quartz glass sheet. In a specific embodiment, as shown in the figure, the light uniformity film 140 is a single integral piece, that is, one integrated light uniformity film 140 is used for each display unit 110 of the entire display module 100, which allows for simplified assembly and Conducive to forming a stable overall structure.

In some embodiments, as shown in FIGS. 1 and 6-7, the light processing component may also include a sharp-light plate 150. More specifically, the sharp-light plate 150 may be disposed on the outside of the light uniformity film 140, that is, on the side facing away from the light-shielding plate 130. The sharp-light plate 150 is provided to sharpen light. More specifically, the sharp-light plate 150 is configured to filter stray light so that the light forming the display information is sharper, thereby making the presented display information more uniformly sharp. In addition, when the light emitting assemblies 111a, 112a are not emitting light, the arrangement of the sharp-light plate 150 and/or the light uniformity film 140 allows the sharp-light plate 150 to be completely black when viewed from the outside, without the internal structure or color being transmitted through the sharp-light plate 150 to avoid visual interference. In one embodiment, sharp-light plate 150 is a black semi-transparent plate. More specifically, the sharp-light plate 150 may be made of plastic. In one specific embodiment, sharp-light plate 150 is a single integral piece, i.e., one integral sharp-light plate 150 is used for each display unit 110 of the entire display module 100, which allows for simplified assembly and facilitates the formation of a robust monolithic structure.

In some embodiments, as shown in FIGS. 1 and 5-6, the sharp-light plate 150 simultaneously constitutes the display panel 150a of the display module 100 for presenting display information. This is beneficial to forming a display module 100 with a compact overall structure, reduces the number of components, simplifies the structure and assembly, and is beneficial to improving cost effectiveness.

In some embodiments, as shown in FIGS. 1 and 5-6, the display module 100 may also be configured to be able to present a panel dividing pattern 151 on the display panel 150a. More specifically, the sharp-light plate 150 of the display module 100 constitutes the display panel 150a, so that in a more specific embodiment the display module 100 can be configured to form a panel dividing pattern 151 on the sharp-light plate 150, especially on the outer side of the sharp-light plate 150, the panel dividing pattern 151 can be divided into respective portions 153 at different positions on the outer side of the sharp-light plate 150, each portion 153 can correspond to a corresponding display unit 110, so that the position information of the respective portions can be facilitated to enable individual operation of the respective display units 110 and thus generate desired display information. In some embodiments, the structure forming the above-mentioned panel dividing pattern 151 may be directly provided on the outside of the display panel 150a or the sharp-light plate 150. This structure is more specifically provided to protrude relative to the display panel 150a or the sharp-light plate 150. Alternatively, instead of directly providing a structure forming the panel dividing pattern 151 on the outside of the display panel 150a or the sharp-light plate 150, a desired panel dividing pattern 151 is displayed on the display panel 150a or the sharp-light plate 150 by a separate pattern display component 160 (schematically shown in FIG. 3). In such embodiments, display module 100 may include pattern display component 160. More specifically, the pattern display component 160 is configured to display different colors or intensities. In one embodiment, the pattern display component 160 is a pattern light-emitting component, such as a set of pattern LED lights. More specifically, the pattern display component 160 and the display assemblies 111, 112 of the display unit 110 are arranged to be controlled or operated independently of each other. In one embodiment, the light-shielding plate 130 may also be provided with a third light-transmitting part (not shown), which allows the pattern display component 160 to form and present the panel dividing pattern 151. More specifically, the pattern display component 160 is aligned with the third light-transmitting part. In one embodiment, the light-shielding plate 130 is provided with a concave pattern 133 on the outside, that is, on the side facing the display panel 150a or the sharp-light plate 150, the concave pattern 133 corresponds to the above-mentioned pattern, and the upper part of the concave pattern 133 Opening allows the pattern display component 160 to be received and accommodated in the concave pattern, thereby forming the above-mentioned panel dividing pattern 151. This is carried out in particular if the light-shielding plate 130 is one piece. More specifically, the concave pattern 133 divides the integrated light-shielding plate 130 into a plurality of light-shielding plate areas 134, and each light-shielding plate area 134 corresponds to a display unit 110.

In some embodiments, as shown in FIGS. 3 and 4, each display unit 110 of the display module 100 may include two display components, namely a first display component 111 and a second display component 112. The first display component 111 may be configured to provide first display information. The second display component 112 may be configured to provide second display information. The second display information may be different from the first display information. For example, the second display information may have a different color, pattern, or brightness than the first display information. For example, the first display component 111 presents blue first display information, and the second display component 112 may present second display information different from blue, such as red. In one embodiment, the first display component 111 may include a first light-emitting component 111a, such as a first set of LED lights. It should be noted that “a group” of LED lights herein may be understood in that the LED lights in the group may be controlled and operated synchronously. More specifically, the second display component 112 may include a second light-emitting component 112a, such as a second set of LED lights. In some embodiments, the first display component 111 and the second display component 112 are configured to be independent of each other, and more specifically configured to be controllable and operable independently of each other, to allow only one of the first display component 111 and the second display component 112 to be One is turned on or both are turned on at the same time or with different brightness and/or different flashing frequencies to provide the desired display information.

In some embodiments, the display module may further include light processing components for processing light emitted by each display unit 110, as described above. The light processing component may be configured to allow processing of light emitted by the first and second light-emitting components 111, 112 to display first and second display information, respectively. In some embodiments, as shown in FIGS. 1-4 and 6-7, the light processing component may include the light-shielding plate 130 in any of the above embodiments, and the light-shielding plate 130 may be provided with a first light-transmitting part accordingly 131 and the second light-transmitting part 132. Each first light-transmitting part 131 may be configured to cooperate with the corresponding first light-emitting component 111a to form first display information, for example, by transmitting the light emitted by the first light-emitting component 111a. Each second light-transmitting part 132 may be configured to cooperate with the corresponding second light-emitting component 112a to form second display information, for example, by transmitting light emitted by the second light-emitting component 112a. In a more specific embodiment, the first light-emitting component 111a may be aligned with the first light-transmitting part pair 131. More specifically, the second light-emitting component 112a may be disposed in alignment with the second light-transmitting part 132.

In some embodiments, as shown in FIGS. 2-4, the first light-transmitting part 131 is configured to be generally circular in shape. In some embodiments, the second light-transmitting part 132 is configured to be generally cross-shaped. It should be noted that these shapes or patterns are merely illustrative and not limiting. In one embodiment, the intersection point of the two intersection lines 132a and 132b forming the cross-shaped second light-transmitting part 132 includes the center of the generally circular first light-transmitting part 131. In a more specific variation, as shown in the figure, the second light-transmitting part 132 is arranged such that its two intersection lines 132a, 132b each extend along the diameter of the generally circular first light-transmitting part 131, to divide the first light-transmitting part 131 into four separate arc segments 131a, 131b, 131c, 131d. More specifically, in such a modification, the light-shielding plate 130 includes each arc segment 131a, 131b, 131c, 131d of the first light-transmitting part 131 and two intersection lines 132a, 132b of the second light-transmitting part 132 Each half defines a fan-shaped non-light-transmitting part 135. In another variant not shown, the second light-transmitting part may be arranged to be surrounded or at least partially surrounded by the generally circular first light-transmitting part. In another variant not shown, the second light-transmitting part may be provided separately from the first light-transmitting part.

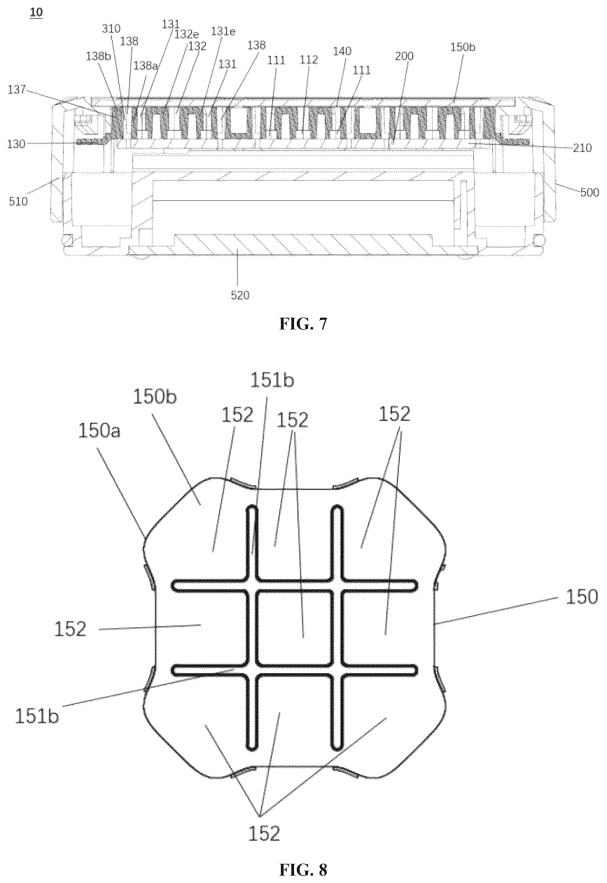

In some embodiments, the display module 100 may further include a control unit 170 configured to control the operation of the display module 100. For example, the control unit 170 may be configured to independently control the operation of the display components 111, 112 of each display unit 110 of the display module 100, and more specifically to independently control the operation of each display component 111, 112 of each display unit 110. More specifically, the display components 111, 112 are provided on the circuit board 171 of the control unit 170. Further, the light-shielding plate 130 may be disposed facing the circuit board 171 of the control unit 170 and at a certain distance from the circuit board 171 in the assembled state (as shown in FIG. 7). More specifically, the light-shielding plate 130 may include a peripheral wall 137, as shown in FIGS. 1-2 and 7, and the peripheral wall 137 may extend from the light-shielding plate 130 transversely to the main surface of the light-shielding plate 130 to the circuit board 171, so that the light-shielding plate 130 can be supported on the circuit board 171 via the peripheral wall 137, thereby ensuring a stable retention of the light-shielding plate 130 relative to the circuit board 171. More specifically, as shown in FIG. 7, one or more of the peripheral walls 131e and 132e of the light-shielding plate 130 defining the respective light-transmitting parts 131 and 132 may also extend from one main side of the light-shielding plate 130 to the circuit board 171, so as to a stable support structure is formed and conducive to good retention of the corresponding display components 111 and 112.

### 2. Intelligent Chess Devices

Another aspect of the present disclosure proposes an intelligent chess device 10 that can play human-computer interactive games in an intelligent manner, ensuring fun while promoting intelligence, and meeting user experience needs.

In one embodiment, as shown in FIGS. 5-6 and 7-8, the intelligent chess device 10 may include a chessboard 150b, a control module 200, a chess piece information input module and a display module 100.

As shown in FIGS. 5-6 and 8, chessboard 150b may be divided into a plurality of chess grids 152, each chess grid 152 corresponding to a piece of chess piece position information. In more specific embodiments, the chess grids 152 may be arranged in any layout, such as in an array in rows and columns, or in a plurality of arrays, or in a circular layout, or a ring or a plurality of ring layouts, etc. In one variation, as shown in FIGS. 5-6 and 8, the chessboard 150b is provided with a pattern, which may be referred to as a grid pattern 151b, which may divide the chessboard 150b into a plurality of chess grids 152; in another variant, the chessboard 150b itself is not provided with any grid pattern, but the board 150b is divided into a plurality of chess grids 152 via other members, such as illumination or transmission of light emitting members on the board 150b. In some embodiments, as shown in FIGS. 5-6 and 8, chessboard 150b is composed of display panel 150a of display module 100. More specifically, the display panel 150a of the display module 100 is composed of the sharp-light plate 150 of the display module 100, and more specifically, is composed of the outside of the sharp-light plate 150. In such an embodiment, the grid pattern 151b on the chessboard 150b may then be formed according to the various manners described with respect to the display module 100, i.e., by providing the structure forming the grid pattern 151b directly on the display panel 150a or the sharp-light plate 150 constituting the chessboard 150b, or by producing the grid pattern 151b on the display panel 150a or the sharp-light plate 150 constituting the chessboard 150b by means of a separate pattern display component 160. At this time, the grid pattern 151b corresponds to the panel dividing pattern 151.

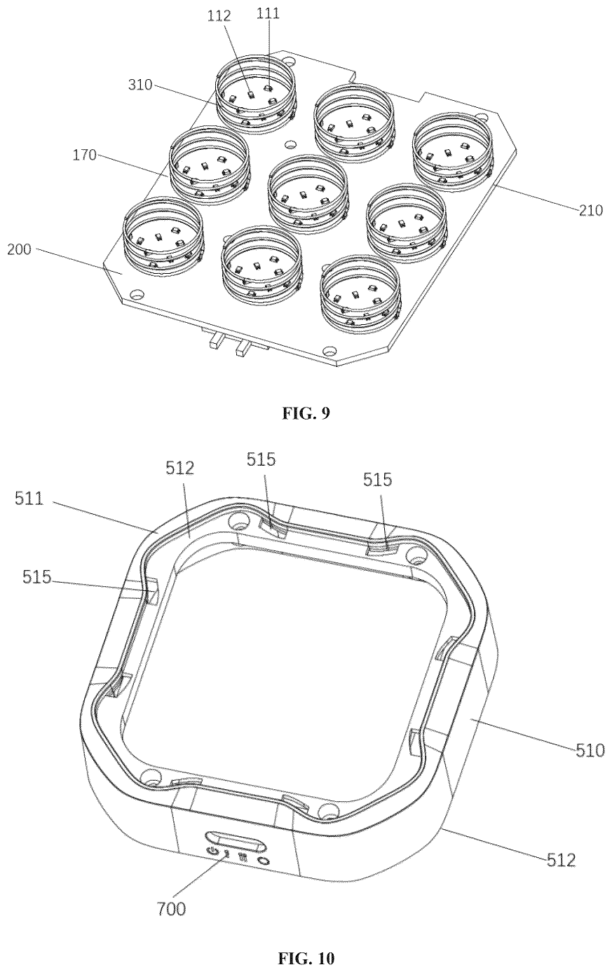

As shown in FIGS. 1-2, 4, 6 and 9, the chess piece information input module is configured to at least receive chess piece position information input by the user and communicate with the control module 200. The display module 100 is configured to be controlled by the control module 200 to present corresponding display information on the chessboard 150b in response to the chess piece position information input by the user. In one embodiment, the control module 200 is configured to include the control unit 170 of the display module 100 described above. More specifically, the control module 200 includes a circuit board 210 containing the circuit board 171 of the control unit 170. More specifically, the chess piece position information input by the user via the chess piece information input module will be transmitted to the control module 200, and the control module 200 controls the display module 100 to present corresponding display information on the chessboard 150b based on the received chess piece position information. In some embodiments, the control module 200 may be configured to control the display module 100 to present corresponding display information at least on the corresponding cell 152 in response to the user input chess piece position information; in some embodiments, in addition to presenting corresponding display information on the cell 152 corresponding to the user-input chess piece position information, the control module may control the display module 100 to present the same or different display information on the associated other cell or chess grids 152.

The display module 100 may be the display module 100 according to any of the above-described embodiments or implementations or modifications. More specifically, each display unit 110 of the display module 100 may be provided to correspond to one of the plurality of chess grids 152 on the chessboard 150b. For example, operation of the display unit 110 will cause corresponding display information to be displayed on the corresponding chess grids 152.

### Chess Piece Information Input Module

In some embodiments, as shown in FIGS. 1-2, 4, 6 and 9, the chess piece information input module may be a capacitive touch key module. In one embodiment, the chess piece information input module may include a sensor chip, a control circuit communicatively connected to the sensor chip, and a sensing electrode 310 provided corresponding to each of the plurality of chess grids 152 on the chessboard 150b. The sensor chip is configured to sense the electric field signal of the sensing electrode 310, and the control circuit is used to process the electric field signal. More specifically, a sensor chip typically consists of a microprocessor and analog circuitry. When the user touches the sensing electrode 310, the electric field on the sensing electrode 310 will change, and the sensor chip can detect this electric field change through analog circuitry. More specifically, the control circuit is configured to receive and process signals transmitted by the sensor chip. The control circuit may be composed of a digital circuit and a logic circuit, and implements touch operations by processing the electric field change signal generated by the sensing electrode 310. Therefore, the capacitive touch key module uses touch sensing and does not require physical pressing and only requires a light touch to trigger a response. In addition, capacitive touch key modules are waterproof, durable, sensitive and other advantages.

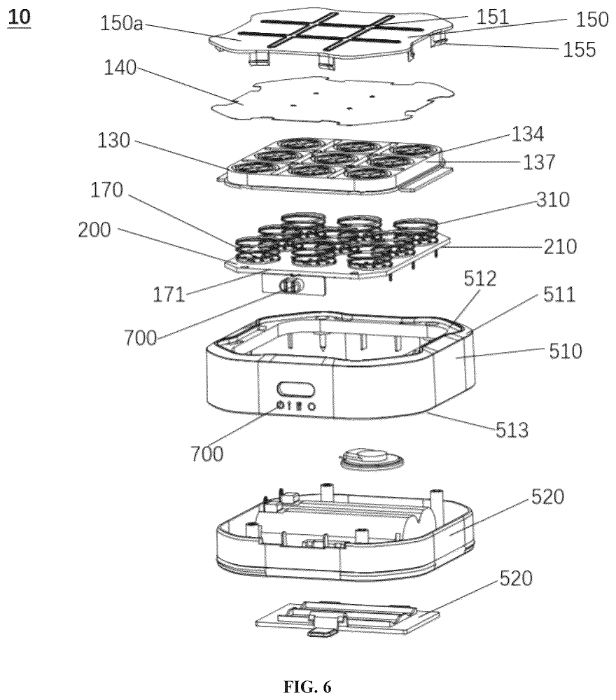

In some embodiments, as shown in FIG. 6, the control module 200 may include a circuit board 210 as described above. More specifically, each control unit of the control module 200 may be arranged on the circuit board 210.

In some embodiments, the sensor chip and control circuit of the capacitive touch key module may be disposed on the circuit board 210 of the control module 200, and each sensing electrode 310 may be a metal sheet disposed between the chessboard 150b and the circuit board 210 or spring, as shown in FIGS. 5-6 and 8. The chessboard 150b is more specifically the display panel 150a or the sharp-light plate 150 of the aforementioned display module 100.

In some embodiments, as shown in FIGS. 1-2, 4, 6 and 9, the light-shielding plate 130 of the light processing component of the display module 100 may also be provided with a holding groove 138 for holding the corresponding sensing electrode 310. For example, the retaining grooves 138 are provided corresponding to the corresponding chess grids 152. More specifically, the sensing electrode 310 is a coil spring, and the holding groove 138 may be disposed around the first light-transmitting part 131 of the light-shielding plate 130, more specifically, around the first light-transmitting part 131 that is generally circular. A sense electrode 310 in the form of a coil spring may be disposed between the board 150b and the circuit board 210 through the retaining slot 138. Thus, the provision of the retention groove 138 allows the retention of the sensing electrode 310 to be achieved in a compact structure. In a more specific embodiment, the light-shielding plate 130 may further include an inner peripheral wall 138a and an outer peripheral wall 138b forming the retaining groove 138, and at least one of the inner peripheral wall 138a and the outer peripheral wall 138b is disposed from one main side of the light-shielding plate 130 toward Circuit board 210 extends a length to reach circuit board 210. Thus, at least one of the inner peripheral wall 138a and the outer peripheral wall 138b extending over a length can achieve good retention of the sensing electrode 310 in the form of a coil spring while also facilitating support of the light-shielding plate 130 on the circuit board 210. More specifically, the light-shielding plate 130 is disposed between the circuit board 210 and the chessboard 150b.

In some embodiments, as shown in FIG. 7, the display components 111 and 112 of each display unit 110 of the display module 100 may also be disposed on the circuit board 210 of the control module 200. More specifically, the light-shielding plate 130 may be pre-fixed to the circuit board 210, such as via gluing or other feasible fixing means. This allows each display unit 110 of the display module 100, the light-shielding plate 130 of the light processing component, the chess piece information input module in the form of a capacitive touch key module and the circuit board 210 of the control module 200 to be pre-assembled into a sub-assembly, which is This is particularly advantageous when the light-shielding plate 130 of the display module 100 is a single-piece one-piece light-shielding plate. This allows simplified assembly, results in a compact structure, and results in a robust overall construction. More specifically, the light-shielding plate 130 may include a peripheral wall 137 extending from one main side of the light-shielding plate 130 to the circuit board 210. This facilitates a stable relative assembly between the light-shielding plate 130 and the circuit board 210.

More specifically, the circuit board 210 of the control module 200 may be screwed to the bottom cover 520 of the housing 500 of the intelligent chess device 10 as will be described below.

In some embodiments not shown, the chess piece information input module may include a push-button module. In an alternative embodiment, the chess piece information input module may include a light sensing module.

### Housing

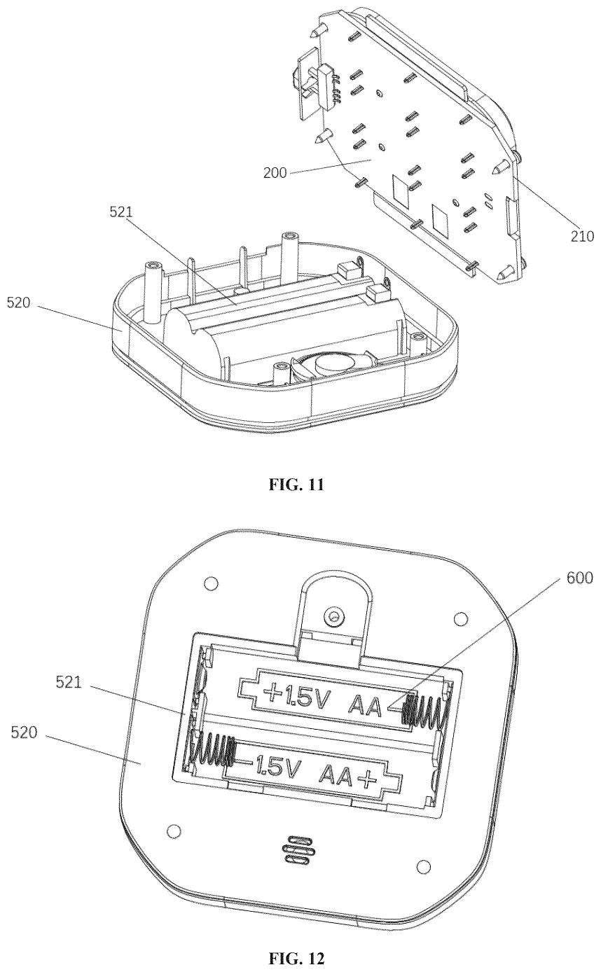

Optionally, as shown in FIGS. 5-7 and 10-12, the intelligent chess device 10 may further include a housing 500, in which the control module 200, at least a part of the display module 100 and at least a part of the chess piece information input module may be accommodated in a cavity defined by the housing 500 to be protected from external environment interference. More specifically, the housing 500 may also be configured to support the board 150b, for example, the board 150b may be fixed to the housing 500. In a specific embodiment, as shown, board 150b is secured to housing 500 by a snap fit, e.g. with a detachable snap fit, allowing board 150b to be detached from housing 500 for replacing board 150b or housing 500 or parts within housing 150b or for servicing or the like without damaging the parts. More specifically, one and the other of several mutually cooperating snap claws 155 and snap recesses 515 may be provided on the board 150b and on the housing 500 respectively, and the snap claws 155 and the snap recesses 515 cooperate to fix the board 150b to the housing 500.

In some embodiments, as shown in FIGS. 5-7 and 10, the housing 500 may include a peripheral wall 510. Housing 500 may be open at a first end 511 of peripheral wall 510 at which board 150b may be disposed to cover the opening. In this case, several snap recesses 515 may be provided at the first end 511 of the peripheral wall 510 of the housing 500, and the board 150b may be provided with a plurality of snap claws 155 protruding from one of the main sides of the board 150b (i.e. the side with the largest surface area). In the assembled state of the board 150b and the housing 500, the snap claws 155 on the board 150b may extend into the snap recesses 515 on the first end 511 of the peripheral wall 510 of the housing 500 and snap into them. Such a configuration facilitates the formation of a particularly compact intelligent chess device 10 that is easily carried and held by a user.

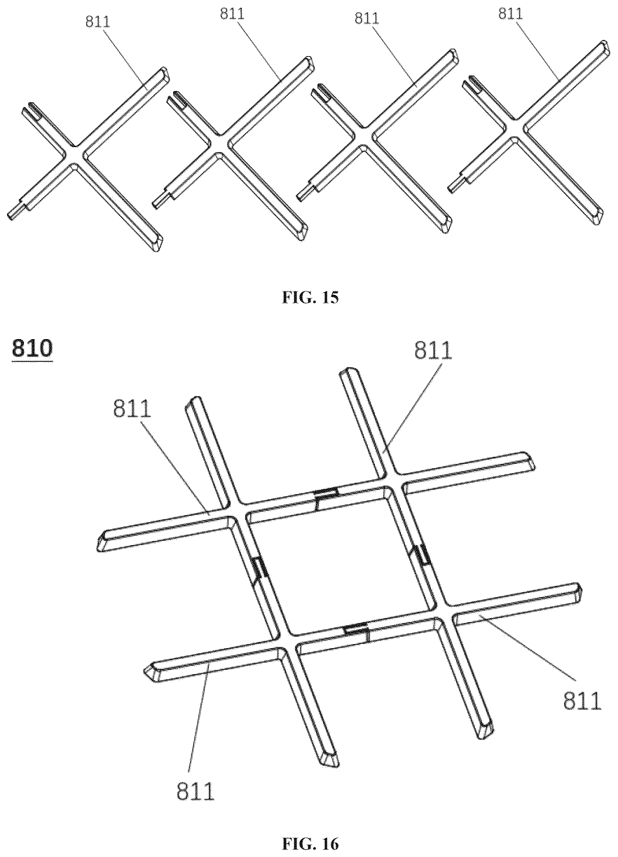

In some embodiments, as shown in FIG. 10, a receiving recess 512 may be provided at the first end 511 of the peripheral wall 510 of the housing 500, the receiving recess 512 being inwardly recessed with respect to an outermost face of the first end 511 of the peripheral wall 510, and the receiving recess 512 being configured to receive the board 150b. In a variant, the board 150b in the assembled state is received in the receiving recess 512 such that the outermost side of the board 150b is flush with the outermost end surface of the first end 511 of the peripheral wall 510 of the housing 500. In another variant, board 150b in the assembled state is received in receiving recess 512 such that the outermost face of board 150b is recessed inwardly relative to the outermost end face of first end 511 of peripheral wall 510 of housing 500, e.g. by a certain length. In the latter variant, more specifically, the board 150b may be configured to allow use in a non-intelligent manner, i.e. it is possible to physically treat the board 150b as a regular board and use the physically present pieces 820, 830 to perform corresponding chess operations on the board (as shown in FIGS. 14 and 17). In such a case, the peripheral wall 510 protruding relative to the outermost side of the board 150b may prevent the pieces 820, 830 from sliding off the board 150b.

The above-mentioned relative fixation between the board 150b and the housing 500 by snap fit is only an illustrative embodiment. Alternatively, or additionally, other fastening means may also be used, including screwing, riveting and welding, among other any other means allowing fixing the board to the casing.

In some embodiments, as shown in FIG. 10, the peripheral wall 510 may be integrally provided. This allows simplifying the design and manufacturing of the peripheral wall 510, and in particular saving the assembly process and corresponding assembly components, thereby contributing to an increase in cost effectiveness.

In some embodiments, as shown in FIGS. 10-12, the peripheral wall 510 of the housing 500 is also open at a second end 513 opposite the first end 511. At this time, the housing 500 may further include a bottom cover 520 provided at the second end 153 of the peripheral wall 510. The bottom cover 520 may be secured to the peripheral wall via snap-fit, threaded coupling, riveting, welding, and the like. As shown in FIG. 12, in some embodiments, the intelligent chess device 10 may include a power module 600. More specifically, the power module 600 may be received in the bottom cover 520, and more specifically housed in a power module cavity 521 provided in the bottom cover 520. This further facilitates the formation of a very compact overall structure of the intelligent chess device 10, thereby making it easy for the user to carry around and hold it.

### 2.1 Intelligent Chess Device—Embodiment (1)

In this embodiment, each display unit 110 of the display module 100 may include only one display component, and the one display component may be the above-mentioned first display component 111 or the second display component 112. More specifically, the one display component is configured to provide information having the same or different patterns. In one embodiment, the display units 110 are controlled independently of each other, and more specifically are controlled independently by the control module 200 to operate independently of each other. More specifically, the control module 200 is configured to be able to control the operating state of the display components of each display unit 110 to be able to display information in different states, for example thereby indicating different game states. More specifically, the display component is configured to present different colors and/or brightness and/or flashing frequencies when in different operating states. The brightness includes, for example, full-lightness called a first brightness and half brightness called a second brightness or any other brightness different from the first brightness and the second brightness, the light intensity of the second brightness being less than the first brightness. The color presented by the display component, such as the light-emitting component, may include any color such as blue, red, yellow, etc.

In some embodiments, intelligent chess device 10 may include one or more game levels. More specifically, each game level may include one or more game sessions, More specifically, each game session may include a question making mode and a question-answering mode that need to be performed sequentially. In one implementation, the control module 200 is further configured to perform a question-generating operation in the question-generating mode of the corresponding game session. More specifically, the control module 200 is also configured to control the intelligent chess device 10 to automatically switch to the answering mode when the questioning mode ends, that is, when the questioning operation is completed.

In some embodiments, the problem-making operation in the problem-making mode comprises performing a chess-making operation on at least two randomly selected chess grids 152 of the plurality of chess grids 152 on the board 150b in a predetermined order. In one embodiment, the control module 200 determines the predetermined order by randomly selecting at least two chess grids 152 from the plurality of chess grids 152 based on the difficulty of the corresponding game session of the corresponding level, e.g., the greater the difficulty, the greater the number of chess grids 152 selected, and then ordering all of the randomly selected chess grids 152 to determine the order in which the respective dispensing operations are to be performed, and performing the dispensing operations on all of the randomly selected chess grids in the predetermined order. Here, the chess arranging operation may be an operation in which the intelligent chess device 10, for example, its control module 200 controls the corresponding display unit 110 to display display information on the corresponding cell 152. Illustratively, as shown in FIGS. 5-6 and 8, the chess grids 152 on the board 150b are divided by the tic-tac-toe grid pattern 151b into three rows and three columns, i.e., nine chess grids 152 in the first row are referred to as chess grids 1, 2, and 3 from left to right, the chess grids 152 in the second row are referred to as chess grids 4, 5, and 6 from left to right, and the chess grids 152 in the third row are referred to as chess grids 7, 8, and 9 from left to right. Illustratively, in a question-answering operation of a game session, cell number 3, cell number 5, and cell number 9 may be randomly selected, and then the three selected chess grids 152 are sequenced, e.g., cell number 9 is sequenced as the first, cell number 3 is sequenced as the second, and cell number 5 is sequenced as the third, whereby the motion is performed on cell number 9, cell number 3, and cell number 5 in a predetermined order. Further, the intelligent chess device 10 records this predetermined ordering and transmits it to the control module 200, for example its storage unit, which storage unit is communicatively coupled with the control module 200; or the storage unit is part of the control module 200.

In some embodiments, each piece-making operation includes turning on a display component of the display unit 110 corresponding to the respective randomly selected grid 152. More specifically, turning on the display component allows display information with a given pattern to be presented on the corresponding cell 152 to indicate that the virtual piece is in place. In a more specific embodiment, each of the dispensing operations includes sequentially turning on the display elements of the corresponding display unit 110 to a full-light state and then to a half-light state. More specifically, when the question-answering operation of the question-answering mode ends, all the turned-on display units 110 are in a half-bright state.

In some embodiments, the answer mode includes an answer operation. More specifically, the answer operation is performed by the user. In one embodiment, the answer operation includes receiving chess piece position information input by the user via the chess piece information input module. More specifically, the user can operate the chess piece information input module and input chess piece position information. The chess piece information input module may be a capacitive touch key module (described in detail below) or a push-button module or a light sensing module according to different embodiments. For example, the chess piece information input module may be provided corresponding to each chess grid 152, so that pressing the corresponding cell 152 completes the input of the chess piece position information of the cell 152. More specifically, each chess grid 152 is provided corresponding to a corresponding display unit 110 and at the same time corresponding to a sensing electrode 310 as described above, thereby allowing simultaneous display of display information and input of chess piece position information in the cell 152.

In some embodiments, the answer operation further includes determining, via the control module 200, whether the user inputs the chess piece position information corresponding to the at least two randomly selected chess grids 152 in the aforementioned predetermined order or the reverse order of the predetermined order. For example, as mentioned above in the example, in a game session where the question-generating operation is implemented as a chess arranging operation on cell No. 9, cell No. 3 and cell No. 5 in a predetermined order, in one implementation, the correct answer operation should be that the user still proceeds in the predetermined order, that is, inputs the chess piece position information of cell No. 9, cell No. 3 and cell No. 5 in sequence; in a variant, the correct answer operation may be for the reverse order of the predetermined order, i.e. entering the chess piece position information for cell number 5, cell number 3 and cell number 9. More specifically, the correct answer operation is performed in a predetermined order or in its reverse order, and only one of them can be performed.

In a more specific embodiment, the answer operation may also include operating the display module according to the judgment result via the control module 200, more specifically, operating the associated display unit 110 of the display module 100. For example, in one embodiment, when the control module 200 determines that the user is inputting the chess piece position information corresponding to the at least two randomly selected chess grids 152 according to the above predetermined order or its reverse order, the control module 200 operates the corresponding Display unit 110: changes from a half-light state to a full-light state, or changes from a half-light state to a full-light state and then changes to an extinguished state. For example, continuing with the example in the previous paragraph, when the user first inputs the chess piece position information corresponding to cell No. 9 according to a predetermined order, the control module 200 will determine that the user's answer operation is correct, and control the display component of the display unit 110 corresponding to cell No. 9 to change from a half-bright state at the end of the question to a full-light state, or from a half-bright state to a full-light state first and then to an extinguished state.

Also, for example, in one embodiment, when the control module 200 determines that the user does not input the chess piece position information corresponding to the at least two randomly selected chess grids 152 according to the above predetermined order or its reverse order, the control module 200 may operate the corresponding display unit 110 to give an error indication or a game end indication. Illustratively, still using the example given above, when the user first inputs the chess piece position information corresponding to cell number 3 without following the predetermined order, the control module 200 may operate the display unit 110 corresponding to cell number 3, or One or more other associated display units 110 provide error indication or game end indication information.

In some embodiments, the display components of the display unit 110 of the display module 100 present the same pattern, such as the circle shape or cross shape or any of the patterns mentioned above. As mentioned above, the pattern may represent a chess piece, more specifically a virtual chess piece. For example, the display pattern appearing at a cell 152 on board 150b represents a playing piece at the corresponding cell 152. In one embodiment, in the case of a correct piece operation, the pattern presented on the corresponding cell 152 is blue, while in the case of an incorrect piece operation or game end, the pattern appearing on the corresponding cell 152 is red, i.e., the appearance of a red pattern gives an error indication or game end indication. Additionally, error indication or game end indication information can be given using a flashing red pattern.

In some embodiments, the intelligent chess device 10 may also include a sound generation module. The sound-emitting module is more specifically controlled by the control module 200. More specifically, the sound-emitting module is provided in the control module 200 in an integrated manner.

In one implementation, the error indication or end indication information of the above answer operation may be provided by the sound module. More specifically, when the control module 200 determines that an erroneous chess operation or the game ends, the control module 200 can control the sound-generating module to emit a preset sound to represent an error indication or end indication information, such as a sigh sound or a cheering sound wait.

In some embodiments, the intelligent chess device 10 is also configured to control the sound-emitting module via the control module 200 to emit a sound concomitant with the chess operation during the question-answering operation. For example, every time a chess operation is performed, the sound-emitting module may emit a sound to Additionally indicate the progress or completion of the chess operation. Alternatively or additionally, the intelligent chess device 10 is further configured to control the sound-emitting module via the control module 200 to emit a sound concomitantly with the input of chess piece position information during the question-answering operation, for example, for each piece of chess piece position information input, the sound-emitting module may Sounds are emitted to additionally indicate correct progress or completion or incorrect progress or end of the game operation.

In one embodiment, the sound generation module may be configured to emit each sound as at least one note in the set of notes {do, re, mi, fa, sol, la, si}. More specifically, the sound generating module may be configured to pronounce one note per piece operation during the questioning operation; more specifically, the sounding module may be configured to emit a note in each correct chess piece position information input during the answer operation, and may emit a sound different from the above note in the case of an error. In a specific implementation, the sound-generating module is configured such that the notes emitted during the answer operation correspond to the notes emitted during the question-generating operation.

In some embodiments, the intelligent chess device 10 is configured to assign a note to each chess operation in the question operation of each game session, the note being selected from the above-mentioned set of notes {do, re, mi, fa, sol, la, si} corresponding to a given discharge, the notes in the subset of notes being arranged sequentially from bass to treble or from treble to bass in their given arrangement. More specifically, the subset of notes may be less than or equal to the set of notes. More specifically, the number of notes making up the subset of notes is less than or equal to the number of randomly selected chess grids 152.

In one embodiment, in a complete question-generating operation, all of the notes assigned to the randomly selected chess grids 152 form a note sequence that is a subset of the notes or the subset of notes and at least partial repeats thereof, in accordance with the “predetermined order” described hereinabove. By way of example, in the question-answering operation, the chess grids 1, 4, 5 and 7 are randomly selected, and the predetermined sequence in which the pieces are placed is determined as follows: cell 5, cell 4, cell 7 and cell 1. For example, in Example 1, the selected subset of notes may be {do, re, mi}, and the notes assigned to cell #5 are do, the notes assigned to cell #4 are re, the notes assigned to cell #7 are mi, and the notes assigned to cell #1 are do, then the notes of the randomly selected chess grids 152 assigned to the notes constitute the note sequence {do, re, mi, do} in a predetermined order, which is the subset of notes plus a partial repetition of the subset of notes. For another example, in Example 2, the selected subset of notes may be {do, re, mi, fa}, then the note assigned to cell #5 is do, the note assigned to cell #4 is re, the note assigned to cell #7 is mi, and the note assigned to cell #1 is fa, then the notes of the randomly selected grid 152 assigned notes constitute the note sequence {do, re, mi, fa} in a predetermined order, which is the subset of notes.

In one implementation, the answering operation is the user's repetition of the answering operation in a predetermined order or the reverse repetition of the answering operation in the reverse order of the predetermined order. Each answering operation is played as the corresponding piece operation when the answer is correct assigned notes, and/or play an error indication sound if the answer is wrong. For example, when the answer slot is specified to repeat the question operation in a predetermined order, continuing with the above example 2, the answer operation will sequentially play the notes in the note sequence {do, re, mi, fa} with the sequential input of the chess piece position information. For another example, when the answer slot is specified to repeat the question operation in the reverse order of the predetermined order, continue with the above example 2, and the answer operation will play the note sequence {fa, mi, re, do} in sequence with the sequential input of the chess piece position information.

In some embodiments, the intelligent chess device 10 may further include a storage unit, which may store one or more questions corresponding to each game session. Further, the question-answering operation includes extracting, by the control module 200, a question from the memory unit prior to performing the piece moving operation, the question comprising a predetermined order for performing the piece moving operation. In a more specific embodiment, the title comprises the note sequence. That is, a question corresponding to each game session has been previously stored in the storage unit, the control module 200 may access and retrieve the question stored in the storage unit, and a predetermined sequence of piece-making operations or note sequences corresponding to the question may be stored in the storage unit together with the question. More specifically, the storage unit may be part of the control module 200.

In an alternative embodiment, the question-answering operation in the question-answering mode comprises a single or a plurality of pieces of play operations on at least two randomly selected chess grids 152 of the plurality of chess grids 152 on the board 150b in a predetermined sequence. That is, in this alternative embodiment, a single or multiple movement may be performed on a randomly selected grid 152. More specifically, when multiple motions are performed on a randomly selected grid 152, the multiple motions may be consecutive or spaced apart by motions of other chess grids 152. That is, the greatest difference between this alternative embodiment and the previous embodiment is that multiple moving operations can be performed on a randomly selected grid 152, and this difference will be primarily described below, with reference to and using the description of the previous embodiment.

In one embodiment, the control module 200 may randomly select at least two chess grids 152 from the plurality of chess grids 152 based on the difficulty of the corresponding game session of the corresponding level, e.g., with greater difficulty selecting a greater number of chess grids 152 or while entraining chess grids 152 that are repeatedly subjected to the game play operation. All of the randomly selected chess grids 152 are sequenced to determine the order in which the moving operations are performed on them, thereby determining the predetermined order and performing the moving operations on the corresponding randomly selected chess grids 152 in the predetermined order. More specifically, a randomly selected grid 152 may be repeated during the sorting process. Exemplarily, the chess grids 152 on board 150b are divided into three rows and three columns by a tic-tac-toe grid pattern 151b, and include chess grids 1, 2, 3, 4, 5, 6, 7, 8, and 9 described above. Illustratively, in a question-answering operation of a game session, cell number 3, cell number 5, and cell number 9 may be randomly selected, and then the three selected chess grids 152 are sequenced, e.g., cell number 9 is sequenced as the first piece-operation cell, cell number 3 is sequenced as the second piece-operation cell, cell number 9 is sequenced as the third piece-operation cell, and cell number 5 is sequenced as the fourth piece-operation cell, whereby the pieces are sequenced on cell number 9, cell number 3, cell number 9, and cell number 5 in a predetermined order.

In some embodiments, each movement includes turning the display element of the display unit 110 corresponding to the respective randomly selected grid 152 on to a full-light state and then to a half-light state. More specifically, activating the display elements allows display information with a given pattern to be presented on the corresponding chess grids 152 to indicate that the pieces are in place. More specifically, when the question-answering operation of the question-answering mode ends, all the turned-on display units 110 are in a half-bright state.

More specifically, the answer operation of the answer mode or the judgment and instructions of whether the answer operation is correct or not can refer to the aforementioned embodiments.

In this alternative embodiment, like the previous embodiment, the intelligent chess device 10 may also include a sound generating module. The sounding module here differs from the previous embodiment in the composition of the final note sequence formed. More specifically, the intelligent chess device 10 may be configured to assign a note to each of the at least two randomly selected chess grids 152. The sound generation module may be configured to play the corresponding note when a chess operation is performed on the corresponding randomly selected grid 152 during the question-generating operation, and more specifically to play the same note that has been assigned to the randomly selected grid 152 each time a chess operation is performed on the same randomly selected grid 152. In a more specific embodiment, the intelligent chess device 10 may be further configured such that during the problem-making operation, the at least two randomly selected chess grids 152 are sequentially ordered in the order in which the first chess-making operation is performed on each randomly selected grid 152, and the at least two randomly selected chess grids 152 are assigned notes arranged from bass to treble or from treble to bass according to the sequential ordering. Illustratively, in a question-answering operation of a game session, cell number 3, cell number 5, and cell number 9 may be randomly selected, and then the three selected chess grids 152 are sequenced, e.g., cell number 9 is sequenced as the first piece-operation cell, cell number 3 is sequenced as the second piece-operation cell, cell number 9 is sequenced as the third piece-operation cell, and cell number 5 is sequenced as the fourth piece-operation cell, whereby the pieces are sequenced on cell number 9, cell number 3, cell number 9, and cell number 5 in a predetermined order. At this time, three notes, e.g., do, re, mi, corresponding to the number of randomly selected chess grids 152 are selected and assigned to the corresponding chess grids 152. The three randomly selected chess grids 152 are ordered sequentially in the order in which the first arranging operation is performed thereon: Cell No. 9, Cell No. 3, and Cell No. 5; then, the note do is assigned to the No. 9 cell, the note re is assigned to the No. 2 cell, and the note mi is assigned to the No. 5 cell in the order of notes from the bass to the treble, thereby forming the note sequence {do, re, do, mi} corresponding to the piece-making operation performed in a predetermined order of the complete question-making operation.

In this alternative embodiment, it may be provided that the answering operation is a repetition of the answering operation by the user in a predetermined order or a reverse repetition of the answering operation in a reverse order of the predetermined order, each answering operation being played for the corresponding randomly selected note assigned to the cell 152 if the answer is correct, and/or an error indicating sound is played in the case of an incorrect answer. These can be referred to the aforementioned embodiments.

Further, in this alternative embodiment, the storage, access, and recall of the topics of each game session may refer to the previous embodiments.

In any of the foregoing embodiments, further, the sound generation module may also be configured to control the sound generation by the control module 200 to indicate at least one of the following game items:
Opening of the intelligent chess device 10;
Entry of a corresponding game mode;
Customs clearance for each game session;
Clearance of each game level;
Corresponding level of level;
Clearance of all game stages for all game levels.

More specifically, the sound-emitting module is further configured to be able to emit different sounds to indicate different game items.

In any of the foregoing embodiments, the intelligent chess device 10 may also be configured to use the number of chess grids 152 that are simultaneously flashing at the beginning or end of each game level to represent the level of the game level.

In any of the foregoing embodiments, further, the intelligent chess device 10 may also be configured to include a pending activation state after being turned on and before playing the game. In a specific embodiment, when the intelligent chess device 10 is turned on, the display units 110 corresponding to all chess grids 152 may be placed in a full-light state and then turned to a half-light state, which may represent a pending activation state. Further, the intelligent chess device 10 may be configured to be activated by the user, for example, by the user inputting arbitrary chess piece position information via the chess piece information input module. More specifically, after activation, the intelligent chess device 10 automatically switches to the question-making mode of the first game session of the first game level.

Further, the intelligent chess device 10 according to any of the foregoing embodiments may be referred to as an intelligent “memory flash” chess.

In some embodiments, the intelligent chess device 10 may further include a switch control module configured to turn the intelligent chess device 10 on and off. Further, the switch control module is configured as a paddle-type or button-type selection module.

### 2.2 Intelligent Chess Device—Embodiment (2)

In this embodiment, the display module 100 of the intelligent chess device 10 may be the display module 100 in any embodiment described with respect to the display module 100, more specifically the display module in such an embodiment-the display module 100 Each display unit 110 includes a first display component 111 and a second display component 112. More specifically, the first display component 111 may be configured to provide first display information, and the second display component 112 may be configured to provide second display information that is different from the first display information. This difference may be reflected in color and/or pattern wait.

In one embodiment, the display units 110 are controlled independently of each other, and more specifically are controlled independently by the control module 200 to operate independently of each other. More specifically, the control module 200 is configured to be able to control the operating state of each of the first display component 111 and the second display component 112 of the respective display unit 110 to be able to display information in different states, for example thereby indicating different game states. More specifically, the first display component 111 and the second display component 112 are configured to present different colors and/or brightness and/or flashing frequencies when in different operating states. The brightness includes, for example, full-lightness called a first brightness and half brightness called a second brightness or any other brightness different from the first brightness and the second brightness, the light intensity of the second brightness being less than the first brightness. The colors presented by the first display component 111 and the second display component 112 may include any color such as blue, red, yellow, etc.

The main difference between this embodiment and the previous embodiments is that additional display components capable of providing additional display information in different colors and/or patterns may be used to indicate information other than the playing pieces, such as answer error indication information, game end information, game level information, etc. The following will mainly focus on the main differences. For the same or similar content, please refer to the relevant description in the foregoing.

In some embodiments, when the control module determines that the user's answer operation is wrong, the control module 200 may control the display module 100 to give an error indication or a game end indication. More specifically, the error indication or the game end indication is implemented by switching between the first display information and the second display information displayed by the corresponding display unit 110. For example, in normal operation, the first display information provided by the first display component 111 may be used to indicate the position of a chess piece at a corresponding cell 152 on the board 150b. In this case, during the problem-making operation in the problem-making mode, more specifically for each piece-making operation, the control module 200 will operate the first display component 111 of the corresponding display unit 110 to present the first display on the corresponding cell 152 Information, which is, for example, a blue overall circle pattern. In addition, further, during the answer operation in the answer mode, in the case of correct answer, the control module 200 will control the first display component 111 of the corresponding display unit 110 to still present the first display information representing the chess piece on the corresponding cell; however, in the case of an incorrect answer, the control module 200 will control the second display component 112 of the corresponding display unit 110 to operate to present second display information on the associated cell 152, the second display information being, for example, a red cross-shaped pattern, so that switching from the first display information to the second display information can be used to represent an error indication or a game end indication.

In some implementations, simultaneous operation of the first display component 111 and the second display component 112 of the respective display unit 110 of the display module 100 may be used to represent game level information. For example, at the beginning or end of each game level, the control module 200 can control both the first display component 111 and the first display component 112 of the corresponding display unit 110 to turn on, for example, to simultaneously display the first display information and the second display information with maximum brightness. Information to represent game level information. More specifically, the number or position of chess grids 152 that simultaneously display the first display information and the second display information may represent a game level. For example, the simultaneous display of first display information and second display information at cell number 4 may represent a fourth level game level; as another example, the simultaneous appearance of four chess grids 152 displaying both first display information and second display information may represent a fourth level game level.

In some embodiments, when the intelligent chess device 10 is turned on, at least one of the first display component 111 or the second display component 112 of the display unit 110 corresponding to all chess grids 152 may be placed in a full-light state and then Turn to a half-light state to represent a pending activation state. Further, the intelligent chess device 10 may be configured to be activated by the user, for example, by the user inputting arbitrary chess piece position information via the chess piece information input module. More specifically, after activation, the intelligent chess device 10 automatically switches to the question-making mode of the first game session of the first game level.

Further, the intelligent chess device 10 according to any of the foregoing embodiments may be referred to as an intelligent “memory flash” chess.

### 2.3 Intelligent Chess Device—Embodiment (3)

In this embodiment, the display module 100 of the intelligent chess device 10 may be the display module 100 in any embodiment described with respect to the display module 100, more specifically the display module 100 in such an embodiment—the display module 100 Each display unit 110 includes a first display component 111 and a second display component 112. More specifically, the first display component 111 may be configured to provide first display information, and the second display component 112 may be configured to provide second display information that is different from the first display information. This difference may be reflected in color and/or pattern wait.

In one embodiment, the display units 110 are controlled independently of each other, and more specifically are controlled independently by the control module 200 to operate independently of each other. More specifically, the control module 200 is configured to be able to control the operating state of each of the first display component 111 and the second display component 112 of the respective display unit 110 to be able to display information in different states, for example thereby indicating different game states. More specifically, the first display component 111 and the second display component 112 are configured to present different colors and/or brightness and/or flashing frequencies when in different operating states. The brightness includes, for example, full-lightness called a first brightness and half brightness called a second brightness or any other brightness different from the first brightness and the second brightness, the light intensity of the second brightness being less than the first brightness. The color presented by the display component can include any color such as blue, red, yellow, etc.

In some embodiments, the control module 200 may be configured to control only one of the first display component 111 and the second display component 112 of the corresponding display unit 110 to be turned on, that is, to be in an active or working state. More specifically, it can be set that the first display information provided by the first display component 111 is used to represent the first chess piece identity, and the second display information provided by the second display component 112 is used to represent the second chess piece identity. In a more specific embodiment, the intelligent chess device 10 is used to play a chess game. More specifically, the first piece identity represents the first party of the two parties in the game, and the second piece identity represents the second party of the two parties in the game. In one embodiment, both the first and second parties of the game are users, more specifically human users, and more specifically the respective game playing operations are performed by the users on behalf of the respective parties. This game mode is referred to as “all-in-all game mode”. In an alternative embodiment, only one of the first and second parties of the game is the user, and this game mode is called “man-machine game mode”. More specifically, the other party's chess operation is implemented by the intelligent chess device 10, for example, by the control module 200 of the intelligent chess device 10.

In one embodiment, when the intelligent chess device 10 performs the corresponding game mode, both sides of the game can alternately perform chess playing operations. Specifically, the chess playing operation is input of chess position information via a user who is one of the two sides of the game, Or the corresponding chess piece identity information, that is, the first display information or the second display information, is displayed on the corresponding cell 152 via the intelligent chess piece device 10 as one of the two sides of the game, more specifically its control module 200. More specifically, when the user performs a chess arranging operation, the user inputs a chess piece position information via the chess piece information input module, and the chess piece position information will be received by the control module 200, and the control module 200 controls the corresponding display unit 110 of the display module 100 to operate to display corresponding display information on the chessboard 150b in response to receiving the chess piece position information. In one embodiment, the corresponding game mode of the intelligent chess device 10 is activated by the user, for example by the user operating the intelligent chess device 10 when the intelligent chess device 10 is turned on. More specifically, the corresponding game mode of the intelligent chess device 10 is activated by the user's first chess arranging operation, that is, by inputting the user-selected chess position information through the chess information input module. Alternatively, the corresponding game mode of the smart board device 10 can also be activated automatically or by the control module.

In some embodiments, there is a state to be activated after the intelligent chess device 10 is turned on and before activating the game mode. In the standby state, one or both of the first display component 111 and the first display component 112 of all or part of the display unit 110 of the display module 100 are turned on, more specifically turned on in a full-light state and then automatically turned to Half-light state, and wait for activation in half-light state.

In some embodiments, the plurality of chess grids 152 on the chessboard 150b are divided by a grid pattern 151b presented on the chessboard 150b. For example, the plurality of chess grids 152 may be arranged in an array comprising rows and columns. More specifically, the intelligent chess device 10 may be configured to represent the victory of any one of the two sides of the game when a given amount of chess pieces are aligned horizontally, vertically or diagonally (e.g., along a diagonal line), and For example, it also represents the end of the game.

In one embodiment, the grid pattern 151b on chessboard 150b is a tic-tac-toe pattern. For example, the board 150b is divided into nine chess grids 152 in three rows and three columns. More specifically, it can be specified that when any three of the nine chess grids 152 have pieces of the same side arranged on them and the three chess grids 152 are in a line, the corresponding side wins.

In some embodiments, the control module 200 is configured to be able to determine the trigger of an intermediate progress state in the game state of the intelligent chess device 10, and after determining the trigger of the intermediate progress state and before the game ends, respond to each subsequent Chess operation controls the operation of a corresponding display unit 110 in the on state. Each subsequent piece operation may be performed by the user or by the control module. More specifically, the control module 200 is configured to control the one corresponding display unit 110 to transition from an on state to an off state. More specifically, when the display unit 110 becomes extinguished, the corresponding cell 152 is again in an “idle” or “available for playing” state, i.e., the playing operation can be performed on that cell 152 again during the next game session. Thereby, a smooth play of the game may be enabled using a very simple board structure. More specifically, the intelligent chess device 10 may also be configured so that, except for one corresponding display unit 110 that is placed in the extinguished state, the remaining display units 110 in the on state remain on, for example, in a full-light state. More specifically, the control module 200 may also be configured to first transition from the full-light state to the half-light state before controlling the one corresponding display unit 110 to transition to the extinguished state. More specifically, the control module 200 is further configured to control the one corresponding display unit 110 to change from the full-light state to the half-light state when performing a piece-making operation before the subsequent piece-making operation corresponding to the off operation, and the half-light state For example, it can be used to remind the user that the cell 152 or the display unit 110 is about to be extinguished.

In some embodiments, the intelligent chess device 10 is configured to have an intermediate play state triggered by the Nth game play operation after the start of the game, where N is an integer ranging between 5-7. More specifically, N is equal to 6. More specifically, the display unit 110 of the cell 152 corresponding to the first N cloth operations of each subsequent operation is the one corresponding display unit 110.

For example, in the case where N is equal to 6, the sixth piece arranging operation after the start of the game triggers the intermediate progress state, and the control module 200 determines the triggering of the intermediate progress state, then the control module 200 controls the display of the chess grids 152 corresponding to the first six piece arranging operations of the seventh piece arranging operation, that is, the first piece arranging operation after the start of the game. Unit 110 changes from on state to extinguished state; optionally, the control module 200 may be configured to control the display unit 110 of the cell 152 corresponding to the first piece operation to change from a full-light state to a half-light state when performing one piece operation (i.e., the 6th piece operation) before the subsequent piece operation (i.e., the 7th piece operation) corresponding to the off operation. Continuing the example, before the end of the game, at each subsequent moving operation after the sixth moving operation after the start of the game, for example, at the eighth moving operation, the control module 200 will control the display units 110 of the chess grids 152 corresponding to the first six moving operations of the eighth moving operation (i.e., the second moving operation) from the on state to the off state; optionally, the control module 200 is further configured to control the display unit 110 of the cell 152 corresponding to the second moving operation to first change from a full-light state to a half-light state during the previous moving operation (i.e., the seventh moving operation) of the eighth moving operation. And so on.

In some embodiments, the control module 200 is also configured to be able to determine the game end state in the game state. More specifically, the control module 200 is also configured to control the first display component 111 or the second display component 112 of the display unit 110 in the on state to flash several times when it is determined that the game is over to represent the corresponding first party or second party. Victory, more specifically, the first display component 111 or the second display component 112 that is controlled to flash several times is connected to a line at this time, that is, the victory condition is satisfied, as described above.

In some embodiments, the intelligent chess device 10 may further include a sound-emitting module, which is controlled by the control module 200 to sound to indicate at least one of the following game items:
Opening of the intelligent chess device 10;
Entry or switching of game modes;
Correct input of chess piece position information by the user or control module 200,
Incorrect input of chess piece position information by the user;
The end of the game.

More specifically, the sound-emitting module may be further configured to be able to emit different sounds to indicate different game items.

In some embodiments, the intelligent chess device 10 may further include a game mode selection module 700 configured to be able to select corresponding game modes, including a human-to-human game mode and a human-to-human game mode. More specifically, the game mode selection module 700 may be configured to receive user input game mode selection information and enter one of the plurality of game modes via the control module 200. The game mode selection module 700 may more specifically be a dial-type or button-type selection module. More specifically, the control module 200 may include various game mode control and operation units, and the game mode selection module 700 may be configured to activate the corresponding game mode control and operation units of the control module 200. In one embodiment, the game mode selection module 700 may be disposed on the housing 500 of the intelligent chess device 10, for example, on the peripheral wall 510 of the housing 500, as shown in FIG. 5. In one embodiment, not shown, game mode selection module 700 may be provided on board 150b.

In some embodiments, the intelligent chess device 10 may further include a switch control module configured to turn the intelligent chess device on and off.

In some embodiments, the game mode selection module 700 and the switch manipulation module are physically implemented as the same paddle-type or push-button-type selection module.

### 2.4 Intelligent Chess Device—Embodiment (4)

According to the embodiment (4) of the intelligent chess device, the intelligent chess device 10 is configured as an integrated intelligent chess device 10, as schematically shown in FIG. 5, and more specifically, the aforementioned embodiment (2) of the intelligent chess device is integrated.) and the aforementioned embodiment (3) of the intelligent chess device, the relevant description can be referred to the above.

The main difference of this embodiment (four) is the configuration of the control module 200. More specifically, the control module 200 of this embodiment (4) is an integrated control module, that is, it integrates the control module for the aforementioned embodiment (2) of the intelligent chess device and the control module for the aforementioned embodiment (2) of the intelligent chess device. Three) control module.

More specifically, in this embodiment (4), the game mode selection module 700 is configured to select the following game modes: the game mode corresponding to the embodiment (2); and the man-to-man game mode and the human-to-human game mode corresponding to Embodiment (3).

In some embodiments, the intelligent chess device 10 may further include a switch control module configured to turn the intelligent chess device on and off.

In some embodiments, the game mode selection module 700 and the switch manipulation module are physically implemented as the same paddle-type or push-button-type selection module.

More specifically, in this embodiment (four), in the standby state of the intelligent chess device 10 corresponding to the embodiment (two), the first display components 111 of all display units 110 of the display module 100 are in a half-bright state. Also specifically, in this embodiment (four), in the standby state of the intelligent chess device 10 corresponding to the embodiment (three), the second display components 112 of all display units 110 of the display module 100 are in a half-bright state.

### 2.5 Modular Chess Device—Embodiment (5)

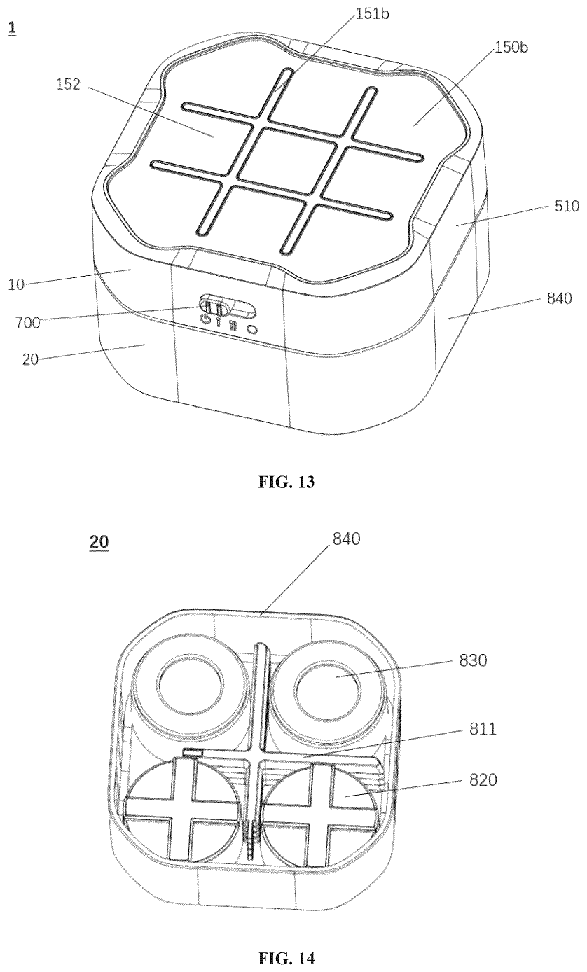

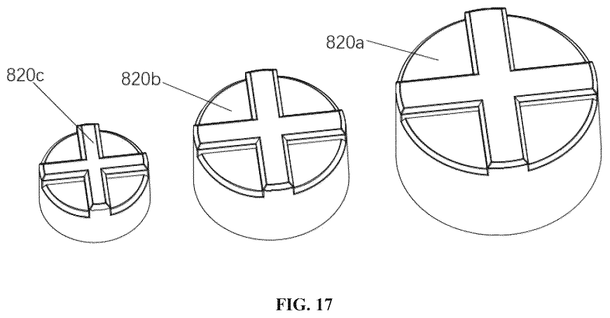

Further embodiments also include a modular chess device 1, as shown in FIGS. 13-17. In this embodiment, the modular chess device 1 is a combination of an intelligent chess device 10 (also referred to herein as a “first device” or “game console”) and a traditional chess device (also referred to herein as a “second device 20” or “physical chess”). This embodiment further increases the playing method of the chess device and expands the usage scenarios of the chess device. As an example, the first device may be any one of the intelligent chess devices 10 described in detail in embodiments (1) to (4). Still as an example, the second device 20 may comprise a chessboard 810 and chess pieces 820, 830, the chessboard 810 of the second device 20 may be a chessboard in the form of a disassembled assembly or a chessboard that is foldable or otherwise reduced in volume accommodation. The second device 20 may further comprise a storage magazine 840 into which the board 810 and the pieces 820, 830 may be stored. On this basis, the second device 20 can be combined with the first device by means of the storage bin 840 to form a modular chess device 1. The combination of the two can be through threaded connection, snap connection, or other connection methods known in the art. As an example, the second apparatus 20 may be a sleeve tic-tac-toe as shown in FIG. 14. The sleeve tic-tac-toe piece comprises a detachably assembled tic-tac-toe board 810, and a plurality of playing pieces 820, 830. As shown in FIGS. 15-16, the tic-tac-toe board 810 of this embodiment is formed by combining four sub-members 811 connected to each other. Adjacent sub-members 811 can be connected in a nested snap-fit manner, which also facilitates disassembly. As also shown in FIGS. 14 and 17, the chess pieces of this embodiment include first chess pieces 820 and second chess pieces 830. As an example, the first chess piece 820 includes three chess pieces that can be nested in sequence, namely a first large chess piece 820a, a first middle chess piece 820b and a first small chess piece 820c. Therein, the first large chess piece 820a has a first cavity extending upwardly from the bottom surface for accommodating the first middle chess piece 820b and/or the first small chess piece 820c. Similarly, the first middle chess piece 820b also has a second cavity extending upwardly from the bottom surface for receiving the first small chess piece 820c.

The first chess piece 820 and the second chess piece 830 may have different colors, such as blue and red, to represent different chess piece identities. Additionally or alternatively, the top surfaces of the first chess piece 820 and the second chess piece 830 may include identifiers representing different chess piece identities, such as “O” and “X” as shown in FIG. 14.

FIG. 14 also gives an example of the assembled state. In this example, the first small chess piece, the first middle chess piece and the first large chess piece are nested in sequence to form the first chess piece 820, and the second small chess piece, the second middle chess piece and the second large chess piece are nested in sequence to form the second chess piece 830. The two sets of the first chess piece 810 and the second chess piece 830, together with the four sub-members 811 of the tic-tac-toe board 810, are stored together in the storage bin 840 to form the second apparatus 20. Finally, the second device 20 is combined with the first device 10 by means of the storage bin 840 to form a modular chess device 1, as shown in FIG. 13.

The above description is only an embodiment, and the present disclosure is not limited thereto. For example, the second device 20 may be a physical piece other than a sleeve tic-tac-toe piece; other types of stowable designs may also be used for the board and chess piece; the method of combining the second device to the first device may also be other connection methods.

The exemplary implementations of the display module, intelligent chess device, and modular chess device proposed in the present disclosure have been described in detail above with reference to preferred embodiments. However, those skilled in the art can understand that without departing from the concept of the present disclosure, various changes and modifications can be made to the above specific embodiments, and various technical features and structures proposed in this disclosure can be variously combined without exceeding the scope of protection of the present disclosure.

The scope of the present disclosure is defined not by the above-described embodiments, but by the appended claims and their equivalents.

1. An intelligent chess device, comprising:
a chessboard divided into a plurality of chess grids, each chess grid corresponding to a chess piece position information;
a chess piece information input module configured to receive at least a chess piece position information input by a user and communicate with the control module;
a display module configured to be controlled by the control module to present corresponding display information on the chessboard in response to the chess piece position information input by the user; and
a control module configured to control the operation of the display module, wherein the chess piece information input module is configured to be communicatively connected with the control module, and the control module is configured to control the display module to present corresponding display information on a display panel in response to the chess piece position information input by the user,
wherein the display module comprises display units corresponding to each of the plurality of chess grids, each of the display units comprising:
a first display component comprising a first light-emitting component and configured to provide a first display information;
a second display component comprising a second light-emitting component and configured to provide a second display information different from the first display information; and
a light processing component arranged to allow processing of light emitted by the first and second light-emitting components to display the first and second display information on the board respectively, wherein the light processing component comprises a light-shielding plate, wherein the light-shielding plate is provided with a first light-transmitting part and a second light-transmitting part, wherein the first light-transmitting part is configured to transmit light emitted by the first light-emitting component to form the first display information, and wherein the second light-transmitting part is configured to transmit light emitted by the second light-emitting component to form the second display information.

2. The intelligent chess device according to claim 1, wherein the first light-emitting component is aligned with the first light-transmitting part; and/or wherein the second light-emitting component is aligned with the second light-transmitting part.

3. The intelligent chess device according to claim 2, wherein the first light-transmitting part is arranged to be generally circular; and/or wherein the second light-transmitting part is arranged to be generally cross-shaped.

4. The intelligent chess device according to claim 3, wherein the intersection point of the two intersection lines forming the cross-shaped second light-transmitting part is the center of the circle of the first light-transmitting part that is generally circular.

5. The intelligent chess device according to claim 4, wherein the two intersection lines of the second light-transmitting part each extend along the diameter of the generally circular first light-transmitting part to divide the first light-transmitting part into four separate arc segments.

6. The intelligent chess device according to claim 1, wherein in a first game mode of the intelligent chess device, the control module is configured to control either of the first display component and the second display component of the corresponding display unit to be turned on, wherein the first display information indicates a first chess piece identity and the second display information indicates a second chess piece identity,
wherein the first game mode is a chess game mode, and the intelligent chess device is configured to alternately perform chess arranging operations by the first party and the second party in the game, and
wherein the chess arranging operation is
inputting chess position information by a user who is one of the first party and the second party; or
controlling the display module by the control module as one of the first party and the second party to display the first display information or the second display information on the corresponding grid.

7. The intelligent chess device according to claim 6, wherein the control module is configured to judge the end state of the game, and to judge the trigger of the intermediate progress state during the game, and to control the operation of a corresponding display unit in the open state in response to each subsequent chess arranging operation after judging the trigger of the intermediate progress state and before the end of the game.

8. The intelligent chess device according to claim 7, wherein the control module is configured to control the one corresponding display unit to change from an on state to an off state, wherein the control module is configured to first change from a full-light state to a half-light state before controlling the one corresponding display unit to change to an off state, and is configured to keep other display units in an on state except for the one corresponding display unit in the on state.

9. The intelligent chess device according to claim 8, wherein the control module is configured to control the one corresponding display unit to turn from a full-light state to a half-light state when a chess arranging operation before a subsequent chess arranging operation corresponding to the off operation is performed.

10. The intelligent chess device according to claim 9, wherein the intermediate progress state is triggered by the Nth chess arranging operations after the start of the game, and wherein N is an integer between 5 and 7.

11. The intelligent chess device according to claim 10, wherein N equals 6.

12. The intelligent chess device according to claim 10, wherein the display unit for the chess grid corresponding to the first N chess arranging operations of each subsequent operation is the corresponding display unit.

13. The intelligent chess device according to claim 1, wherein in a second game mode of the intelligent chess device, the control module is configured to control only one of the first display component and the second display component of the corresponding display unit to be turned on, and wherein the first display information represents a chess piece, and/or the second display information represents an error indication or a game-end indication.

14. The intelligent chess device according to claim 13, wherein the second game mode includes one or more game levels, each game level includes one or more game sessions, each game session includes a question-generating mode and a question-answering mode performed sequentially,
wherein the control module is further configured to perform a question-generating operation in the question-generating mode of the corresponding game session; and
wherein the question-generating operation includes placing a chess piece on at least two randomly selected chess grids in a predetermined order, each chess arranging operation including turning on the first display component or the second display component of the display unit corresponding to the randomly selected chess grids.

15. The intelligent chess device according to claim 14, wherein the question-answering mode includes a question-answering operation, the question-answering operation including receiving the chess piece position information input by the user via the chess piece information input module,
wherein the question-answering operation further includes determining, via the control module, whether the user inputs chess piece position information corresponding to the at least two randomly selected chess grids in the predetermined order or the reverse order of the predetermined order, and
wherein the question-answering operation further includes operating the display module via the control module based on the determination result.

16. The intelligent chess device according to claim 15, wherein each chess arranging operation comprises turning on the first display component or the second display component of the corresponding display unit to a full-light state and then turning to a half-light state, and all the turned-on display units are in a half-light state at the end of the question-generating operation;
wherein the question-answering operation comprises the following steps:
when the control module judges that the user is inputting the position information of the chess pieces corresponding to the at least two randomly selected grids in the predetermined order or the reverse order of the predetermined order, the control module operates the corresponding display unit to change from a half-light state to a full-light state, or to change from a half-light state to a full-light state and then to an off state; and/or
when the control module judges that the user does not input the position information of the chess pieces corresponding to the at least two randomly selected grids according to the predetermined order or the reverse order of the predetermined order, the control module operates the corresponding display unit to give an error indication or a game end indication.

17. The intelligent chess device according to claim 16, further comprising a sound-emitting module, wherein the control module is further configured to control the sound-emitting module to:
emit a sound during the question-generating operation in conjunction with the chess arranging operation; and/or
emit a sound during the question-answering operation in conjunction with the input of the chess piece position information,
wherein, the sound-emitting module is further configured to emit at least one note from the set of notes do, re, mi, fa, sol, la, si each time,
wherein the intelligent chess device is further configured to assign a note to each chess arranging operation in the question-generating operation, the note being selected from the set of notes corresponding to a given arrangement of a subset of musical notes, wherein the notes in the subset are arranged in a given pattern from low to high or from high to low,
wherein all the notes of the randomly selected assigned grids form a note sequence in the predetermined order, the note sequence being the subset of notes or a repetition of the subset of notes and at least a portion thereof, and/or the question-answering operation is a user repeating the question-generating operation in the predetermined order or repeating the question-generating operation in reverse order, wherein each question-answering operation plays the note assigned to the corresponding chess arranging operation if the answer is correct, and/or plays an error indication sound if the answer is incorrect, and
wherein the subset of musical notes is less than or equal to the set of musical notes.

18. The intelligent chess device according to claim 13, wherein the second game mode includes one or more game levels, each game level includes one or more game sessions, and each game session includes a question-generating mode and a question-answering mode performed sequentially,
wherein the control module is further configured to perform a question-generating operation in the question-generating mode of the corresponding game session,
wherein the question-generating operation includes performing one or more chess arranging operations on at least two randomly selected chess grids in a predetermined order, and each chess arranging operation includes displaying the first display component of the display unit corresponding to the randomly selected chess grid, alternatively, the second display component is configured to be turned on to a full-light state and then switched to a half-light state,
wherein at the end of the question-generating operation, all activated display units are in a half-light state,
wherein the question-answering mode includes a question-answering operation which includes receiving the chess piece position information input by the user via the chess piece information input module,
wherein the question-answering operation further includes the control module determining whether the user inputs the chess piece position information corresponding to the at least two display units in the predetermined order or the reverse order of the predetermined order, and
wherein the question-answering operation further includes the control module operating the display module based on the determination result.

19. The intelligent chess device according to claim 18, wherein the question-answering operation includes:
when the control module determines that the user is inputting the chess piece position information corresponding to the at least two display units in the predetermined order or the reverse order of the predetermined order, the control module operates the corresponding display unit to change from a half-light state to a full-light state, or to change from a half-light state to a full-light state and then to an off state; and/or
when the control module determines that the user does not input the chess piece position information corresponding to the at least two randomly selected chess grids in the predetermined order or the reverse order of the predetermined order, the control module operates the corresponding display unit to give an error indication or a game end indication.

20. The intelligent chess device according to claim 19, further comprising a sound-emitting module, wherein the control module is further configured to control the sound-emitting module to:
emit a sound during the question-generating operation in conjunction with the chess arranging operation; and/or
emit a sound during the question-answering operation in conjunction with the input of the piece position information,
wherein the sound-emitting module is further configured to emit at least one note from the set of notes do, re, mi, fa, sol, la, si each time,
wherein the intelligent chess device is further configured to assign a note to each of the at least two randomly selected grids,
wherein the sound-emitting module is configured to play the corresponding note when the chess arranging operation is performed on the corresponding randomly selected grid during the question-generating operation; and/or
wherein the question-answering operation is a repetition of the question-generating operation by the user in the predetermined order or a reverse repetition of the question-generating operation in the reverse order of the predetermined order, wherein each question-answering operation plays the note assigned to the corresponding randomly selected grid if the answer is correct, and/or plays an error indication sound if the answer is incorrect.

21. The intelligent chess device according to claim 20, further configured such that during the question-answering operation, the at least two randomly selected grids are sequentially ordered according to the order in which the first chess arranging operation is performed on each of the randomly selected chess girds, and notes arranged from low to high or from high to low are assigned to the at least two randomly selected chess grids according to the sequential order.

22. The intelligent chess device according to claim 1, wherein the intelligent chess device is tic-tac-toe or a memory-based quick chess game.
